(19) United States
(12) Patent Application Publication
(10) Pub. No.: US 2021/0195254 A1
(43) Pub. Date: Jun. 24, 2021

(54) DEVICE FOR TRANSMITTING BROADCAST SIGNAL, DEVICE FOR RECEIVING BROADCAST SIGNAL, METHOD FOR TRANSMITTING BROADCAST SIGNAL, AND METHOD FOR RECEIVING BROADCAST SIGNAL

(71) Applicant: LG ELECTRONICS INC., Seoul (KR)

(72) Inventors: Hyunmook OH, Seoul (KR); Jongyeul SUH, Seoul (KR)

(21) Appl. No.: 16/074,312

(22) PCT Filed: Feb. 1, 2017
(86) PCT No.: PCT/KR2017/001076

§ 371 Date: Jul. 31, 2018

Related U.S. Application Data
(60) Provisional application No. 62/289,861, filed on Feb. 1, 2016.
(60) Provisional application No. 62/294,316, filed on Feb. 12, 2016.
(60) Provisional application No. 62/333,774, filed on May 9, 2016.
(60) Provisional application No. 62/405,230, filed on Oct. 6, 2016.

(51) Int. Cl. H04N 21/2343; H04N 21/81; H04N 21/234

(52) U.S. Cl. CPC H04N 21/2343; H04N 21/23418; H04N 21/8193

(57) ABSTRACT

Provided in the present invention is a method for transmitting a broadcast signal. The method for transmitting a broadcast signal, according to the present invention, provides a system capable of supporting a next-generation broadcasting service in an environment supporting a next-generation hybrid broadcast which uses a terrestrial broadcasting network and an Internet network. Also provided is an efficient way of signaling encompassing the terrestrial broadcasting network and the Internet network in the environment supporting the next-generation hybrid broadcast.

### TECHNICAL FIELD

The present invention relates to a broadcast signal transmission apparatus, a broadcast signal reception apparatus, and broadcast signal transmission/reception methods.

### BACKGROUND ART

With the increase in video signal processing speeds, research has been conducted on a method of encoding/decoding ultra-high definition (UHD) video.

UHD content aims to provide image quality that is improved over that of conventional content in various aspects. To this end, research and development have been conducted on UHD video elements in various fields, including a broadcasting field. Meanwhile, demand for improved viewer experience from the aspects of color and luminance, which is not provided by conventional content, has increased. As a result, efforts have been made to provide high-quality images by extending the color and luminance representation ranges, among various elements constituting UHD video.

UHD broadcasting aims to provide image quality and immersiveness that are improved over those of conventional HD broadcasting to viewers in various aspects. To this end, an HDR (high dynamic range) and a WCG (wide color gamut) are expected to be introduced as an example of a method of extending the range of luminance and color represented in UHD content to the range of luminance and color that can be perceived by the actual human visual system. That is, as content provides higher contrast and improved color, users who watch UHD content feel greater immersiveness and realism.

### DISCLOSURE

### Technical Problem

It is an object of the present invention to provide signaling for outputting a plurality of videos from a single video stream.

It is another object of the present invention to signal information about an additional transfer function, which is additionally applied, in addition to a transfer function that is fundamentally applied.

It is a further object of the present invention to signal information about the color volume of content.

### Technical Solution

The present invention proposes a system capable of effectively supporting next-generation broadcast services in an environment supporting next-generation hybrid broadcasting using terrestrial broadcast networks and the Internet and related signaling methods as included and approximately described herein according to objects of the present invention.

### Advantageous Effects

According to the present invention, it is possible to provide signaling for outputting a plurality of videos from a single video stream.

According to the present invention, it is possible to signal information about an additional transfer function, which is additionally applied, in addition to a transfer function that is fundamentally applied.

According to the present invention, it is possible to signal information about the color volume of content.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a protocol stack according to one embodiment of the present invention;

FIG. 2 is a diagram illustrating a service discovery procedure according to one embodiment of the present invention;

FIG. 3 is a diagram showing a low level signaling (LLS) table and a service list table (SLT) according to one embodiment of the present invention;

FIG. 4 is a diagram showing a USBD and an S-TSID delivered through ROUTE according to one embodiment of the present invention;

FIG. 5 is a diagram showing a USBD delivered through MMT according to one embodiment of the present invention;

FIG. 6 is a diagram showing link layer operation according to one embodiment of the present invention;

FIG. 7 is a diagram showing a link mapping table (LMT) according to one embodiment of the present invention;

FIG. 8 is a view showing the structure of a broadcast signal transmission and reception system according to an embodiment of the present invention;

FIG. 9 is a view showing the structure of a broadcast signal reception apparatus according to an embodiment of the present invention;

FIG. 10 is a view showing the syntax of SPS (sequence parameter set) RBSP (raw byte sequence payload) according to an embodiment of the present invention;

FIG. 11 is a view showing the syntax of an sps_multi_output_extension descriptor according to an embodiment of the present invention;

FIG. 12 is a view showing the description of values indicated by an output_transfer_function field, an output_color_primaries field, and an output_matrix_coefficient field according to an embodiment of the present invention;

FIG. 13 is a view showing the syntax of an sps_multi_output_extension descriptor according to another embodiment of the present invention;

FIG. 14 is a view showing the syntax of a multi_output_extension_vui_parameters descriptor according to an embodiment of the present invention;

FIG. 15 is a view showing the syntax of SPS (sequence parameter set) RBSP (raw byte sequence payload) according to another embodiment of the present invention;

FIG. 16 is a view showing the syntax of SPS (sequence parameter set) RBSP (raw byte sequence payload) according to another embodiment of the present invention;

FIG. 17 is a view showing the syntax of an sps_multi_output_extension descriptor according to another embodiment of the present invention;

FIG. 18 is a view showing the description of values indicated by a multi_output_chroma_format_idc field and a multi_output_color_signal_representation field according to an embodiment of the present invention;

FIG. 19 is a view showing the syntax of SPS RBSP and an sps_multi_output_extension descriptor according to another embodiment of the present invention;

FIG. 20 is a view showing the syntax of SPS RBSP and an sps_multi_output_extension descriptor according to another embodiment of the present invention;

FIG. 21 is a view showing the structure of a broadcast signal transmission and reception system according to another embodiment of the present invention;

FIG. 22 is a view showing the structure of a broadcast signal reception apparatus according to another embodiment of the present invention;

FIG. 23 is a view showing the operation of a video-processing processor and a presentation additional transfer function application processor of a post-processing processor according to an embodiment of the present invention;

FIG. 24 is a view showing the syntax of an additional_transfer_function_info descriptor according to an embodiment of the present invention;

FIG. 25 is a view showing the description of values indicated by a signal_type field, a TF_type field, an encoded_ATF_type field, an encoded_ATF_domain_type field, and a presentation_ATF_type field according to an embodiment of the present invention;

FIG. 26 is a view showing a method of signaling additional transfer function information according to an embodiment of the present invention;

FIG. 27 is a view showing a method of signaling additional transfer function information according to another embodiment of the present invention;

FIG. 28 is a view showing a method of signaling additional transfer function information according to another embodiment of the present invention;

FIG. 29 is a view showing a method of signaling additional transfer function information according to another embodiment of the present invention;

FIG. 30 is a view showing a method of signaling additional transfer function information according to a further embodiment of the present invention;

FIG. 31 is a view showing the syntax of additional_transfer_function_info_descriptor according to an embodiment of the present invention;

FIG. 32 is a view illustrating the case in which additional transfer function information according to an embodiment of the present invention is signaled through a PMT (program map table);

FIG. 33 is a view illustrating the case in which additional transfer function information according to an embodiment of the present invention is signaled through an EIT (event information table);

FIG. 34 is a view showing the structure of a broadcast signal reception apparatus according to another embodiment of the present invention;

FIG. 35 is a view showing the syntax of a content_colour_volume descriptor according to an embodiment of the present invention;

FIG. 36 is a view showing a broadcast signal transmission method according to an embodiment of the present invention;

FIG. 37 is a view showing a broadcast signal reception method according to an embodiment of the present invention;

FIG. 38 is a view showing the structure of a broadcast signal transmission apparatus according to an embodiment of the present invention; and

FIG. 39 is a view showing the structure of a broadcast signal reception apparatus according to an embodiment of the present invention.

### BEST MODE

The present invention provides apparatuses and methods for transmitting and receiving broadcast signals for future broadcast services. Future broadcast services according to an embodiment of the present invention include a terrestrial broadcast service, a mobile broadcast service, an ultra high definition television (UHDTV) service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc. The present invention proposes a physical profile (or system) optimized to minimize receiver complexity while accomplishing performance required for a specific purpose.

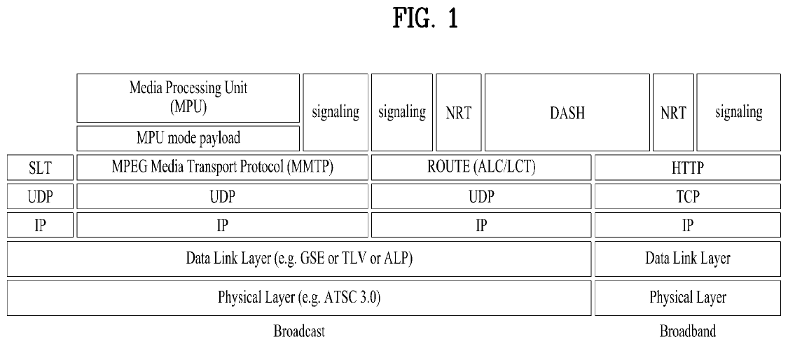

FIG. 1 is a diagram showing a protocol stack according to an embodiment of the present invention.

A service may be delivered to a receiver through a plurality of layers. First, a transmission side may generate service data. The service data may be processed for transmission at a delivery layer of the transmission side and the service data may be encoded into a broadcast signal and transmitted over a broadcast or broadband network at a physical layer.

Here, the service data may be generated in an ISO base media file format (BMFF). ISO BMFF media files may be used for broadcast/broadband network delivery, media encapsulation and/or synchronization format. Here, the service data is all data related to the service and may include service components configuring a linear service, signaling information thereof, non-real time (NRT) data and other files.

The delivery layer will be described. The delivery layer may provide a function for transmitting service data. The service data may be delivered over a broadcast and/or broadband network.

A service delivery through a broadcast network may include two methods.

As a first method, service data may be processed in media processing units (MPUs) based on MPEG media transport (MMT) and transmitted using an MMT protocol (MMTP). In this case, the service data delivered using the MMTP may include service components for a linear service and/or service signaling information thereof.

As a second method, service data may be processed into DASH segments and transmitted using real time object delivery over unidirectional transport (ROUTE), based on MPEG DASH. In this case, the service data delivered through the ROUTE protocol may include service components for a linear service, service signaling information thereof and/or NRT data. That is, the NRT data and non-timed data such as files may be delivered through ROUTE.

Data processed according to MMTP or ROUTE protocol may be processed into IP packets through a UDP/IP layer. In service data delivery over the broadcast network, a service list table (SLT) may also be delivered over the broadcast network through a UDP/IP layer. The SLT may be delivered in a low level signaling (LLS) table. The SLT and LLS table will be described later.

IP packets may be processed into link layer packets in a link layer. The link layer may encapsulate various formats of data delivered from a higher layer into link layer packets and then deliver the packets to a physical layer. The link layer will be described later.

In hybrid service delivery, at least one service element may be delivered through a broadband path. In hybrid service delivery, data delivered over broadband may include service components of a DASH format, service signaling information thereof and/or NRT data. This data may be processed through HTTP/TCP/IP and delivered to a physical layer for broadband transmission through a link layer for broadband transmission.

The physical layer may process the data received from the delivery layer (higher layer and/or link layer) and transmit the data over the broadcast or broadband network. A detailed description of the physical layer will be given later.

The service will be described. The service may be a collection of service components displayed to a user, the components may be of various media types, the service may be continuous or intermittent, the service may be real time or non-real time, and a real-time service may include a sequence of TV programs.

The service may have various types. First, the service may be a linear audio/video or audio service having app based enhancement. Second, the service may be an app based service, reproduction/configuration of which is controlled by a downloaded application. Third, the service may be an ESG service for providing an electronic service guide (ESG). Fourth, the service may be an emergency alert (EA) service for providing emergency alert information.

When a linear service without app based enhancement is delivered over the broadcast network, the service component may be delivered by (1) one or more ROUTE sessions or (2) one or more MMTP sessions.

When a linear service having app based enhancement is delivered over the broadcast network, the service component may be delivered by (1) one or more ROUTE sessions or (2) zero or more MMTP sessions. In this case, data used for app based enhancement may be delivered through a ROUTE session in the form of NRT data or other files. In one embodiment of the present invention, simultaneous delivery of linear service components (streaming media components) of one service using two protocols may not be allowed.

When an app based service is delivered over the broadcast network, the service component may be delivered by one or more ROUTE sessions. In this case, the service data used for the app based service may be delivered through the ROUTE session in the form of NRT data or other files.

Some service components of such a service, some NRT data, files, etc. may be delivered through broadband (hybrid service delivery).

That is, in one embodiment of the present invention, linear service components of one service may be delivered through the MMT protocol. In another embodiment of the present invention, the linear service components of one service may be delivered through the ROUTE protocol. In another embodiment of the present invention, the linear service components of one service and NRT data (NRT service components) may be delivered through the ROUTE protocol. In another embodiment of the present invention, the linear service components of one service may be delivered through the MMT protocol and the NRT data (NRT service components) may be delivered through the ROUTE protocol. In the above-described embodiments, some service components of the service or some NRT data may be delivered through broadband. Here, the app based service and data regarding app based enhancement may be delivered over the broadcast network according to ROUTE or through broadband in the form of NRT data. NRT data may be referred to as locally cached data.

Each ROUTE session includes one or more LCT sessions for wholly or partially delivering content components configuring the service. In streaming service delivery, the LCT session may deliver individual components of a user service, such as audio, video or closed caption stream. The streaming media is formatted into a DASH segment.

Each MMTP session includes one or more MMTP packet flows for delivering all or some of content components or an MMT signaling message. The MMTP packet flow may deliver a component formatted into MPU or an MMT signaling message.

For delivery of an NRT user service or system metadata, the LCT session delivers a file based content item. Such content files may include consecutive (timed) or discrete (non-timed) media components of the NRT service or metadata such as service signaling or ESG fragments. System metadata such as service signaling or ESG fragments may be delivered through the signaling message mode of the MMTP.

A receiver may detect a broadcast signal while a tuner tunes to frequencies. The receiver may extract and send an SLT to a processing module. The SLT parser may parse the SLT and acquire and store data in a channel map. The receiver may acquire and deliver bootstrap information of the SLT to a ROUTE or MMT client. The receiver may acquire and store an SLS. USBD may be acquired and parsed by a signaling parser.

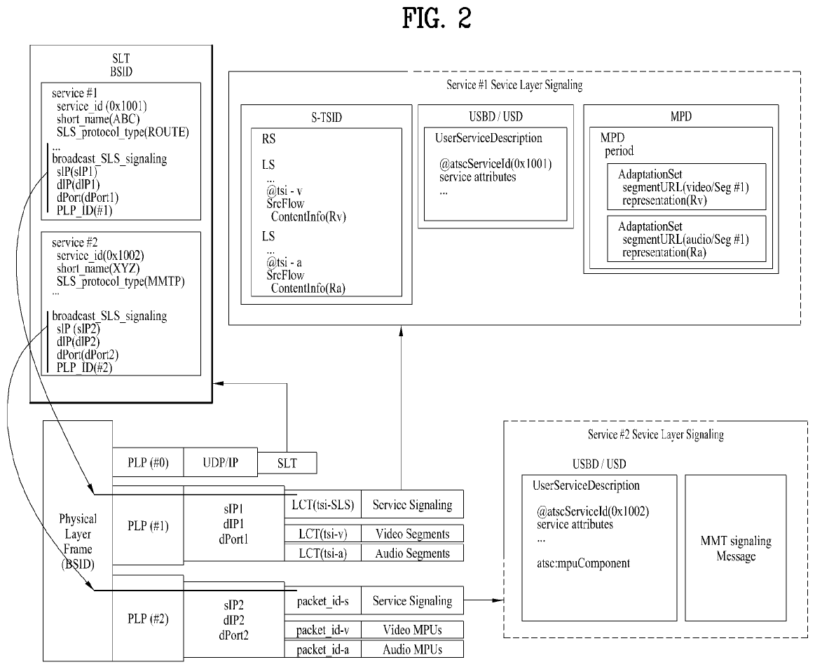

FIG. 2 is a diagram showing a service discovery procedure according to one embodiment of the present invention.

A broadcast stream delivered by a broadcast signal frame of a physical layer may carry low level signaling (LLS). LLS data may be carried through payload of IP packets delivered to a well-known IP address/port. This LLS may include an SLT according to type thereof. The LLS data may be formatted in the form of an LLS table. A first byte of every UDP/IP packet carrying the LLS data may be the start of the LLS table. Unlike the shown embodiment, an IP stream for delivering the LLS data may be delivered to a PLP along with other service data.

The SLT may enable the receiver to generate a service list through fast channel scan and provides access information for locating the SLS. The SLT includes bootstrap information. This bootstrap information may enable the receiver to acquire service layer signaling (SLS) of each service. When the SLS, that is, service signaling information, is delivered through ROUTE, the bootstrap information may include an LCT channel carrying the SLS, a destination IP address of a ROUTE session including the LCT channel and destination port information. When the SLS is delivered through the MMT, the bootstrap information may include a destination IP address of an MMTP session carrying the SLS and destination port information.

In the shown embodiment, the SLS of service #1 described in the SLT is delivered through ROUTE and the SLT may include bootstrap information sIP1, dIP1 and dPort1 of the ROUTE session including the LCT channel delivered by the SLS. The SLS of service #2 described in the SLT is delivered through MMT and the SLT may include bootstrap information sIP2, dIP2 and dPort2 of the MMTP session including the MMTP packet flow delivered by the SLS.

The SLS is signaling information describing the properties of the service and may include receiver capability information for significantly reproducing the service or providing information for acquiring the service and the service component of the service. When each service has separate service signaling, the receiver acquires appropriate SLS for a desired service without parsing all SLSs delivered within a broadcast stream.

When the SLS is delivered through the ROUTE protocol, the SLS may be delivered through a dedicated LCT channel of a ROUTE session indicated by the SLT. In some embodiments, this LCT channel may be an LCT channel identified by tsi=0. In this case, the SLS may include a user service bundle description (USBD)/user service description (USD), service-based transport session instance description (S-TSID) and/or media presentation description (MPD).

Here, USBD/USD is one of SLS fragments and may serve as a signaling hub describing detailed description information of a service. The USBD may include service identification information, device capability information, etc. The USBD may include reference information (URI reference) of other SLS fragments (S-TSID, MPD, etc.). That is, the USBD/USD may reference the S-TSID and the MPD. In addition, the USBD may further include metadata information for enabling the receiver to decide a transmission mode (broadcast/broadband network). A detailed description of the USBD/USD will be given below.

The S-TSID is one of SLS fragments and may provide overall session description information of a transport session carrying the service component of the service. The S-TSID may provide the ROUTE session through which the service component of the service is delivered and/or transport session description information for the LCT channel of the ROUTE session. The S-TSID may provide component acquisition information of service components associated with one service. The S-TSID may provide mapping between DASH representation of the MPD and the tsi of the service component. The component acquisition information of the S-TSID may be provided in the form of the identifier of the associated DASH representation and tsi and may or may not include a PLP ID in some embodiments. Through the component acquisition information, the receiver may collect audio/video components of one service and perform buffering and decoding of DASH media segments. The S-TSID may be referenced by the USBD as described above. A detailed description of the S-TSID will be given below.

The MPD is one of SLS fragments and may provide a description of DASH media presentation of the service. The MPD may provide a resource identifier of media segments and provide context information within the media presentation of the identified resources. The MPD may describe DASH representation (service component) delivered over the broadcast network and describe additional DASH presentation delivered over broadband (hybrid delivery). The MPD may be referenced by the USBD as described above.

When the SLS is delivered through the MMT protocol, the SLS may be delivered through a dedicated MMTP packet flow of the MMTP session indicated by the SLT. In some embodiments, the packet_id of the MMTP packets delivering the SLS may have a value of 00. In this case, the SLS may include a USBD/USD and/or MMT packet (MP) table.

Here, the USBD is one of SLS fragments and may describe detailed description information of a service as in ROUTE. This USBD may include reference information (URI information) of other SLS fragments. The USBD of the MMT may reference an MP table of MMT signaling. In some embodiments, the USBD of the MMT may include reference information of the S-TSID and/or the MPD. Here, the S-TSID is for NRT data delivered through the ROUTE protocol. Even when a linear service component is delivered through the MMT protocol, NRT data may be delivered via the ROUTE protocol. The MPD is for a service component delivered over broadband in hybrid service delivery. The detailed description of the USBD of the MMT will be given below.

The MP table is a signaling message of the MMT for MPU components and may provide overall session description information of an MMTP session carrying the service component of the service. In addition, the MP table may include a description of an asset delivered through the MMTP session. The MP table is streaming signaling information for MPU components and may provide a list of assets corresponding to one service and location information (component acquisition information) of these components. The detailed description of the MP table may be defined in the MMT or modified. Here, the asset is a multimedia data entity, is combined by one unique ID, and may mean a data entity used to one multimedia presentation. The asset may correspond to service components configuring one service. A streaming service component (MPU) corresponding to a desired service may be accessed using the MP table. The MP table may be referenced by the USBD as described above.

The other MMT signaling messages may be defined. Additional information associated with the service and the MMTP session may be described by such MMT signaling messages.

The ROUTE session is identified by a source IP address, a destination IP address and a destination port number. The LCT session is identified by a unique transport session identifier (TSI) within the range of a parent ROUTE session. The MMTP session is identified by a destination IP address and a destination port number. The MMTP packet flow is identified by a unique packet_id within the range of a parent MMTP session.

In case of ROUTE, the S-TSID, the USBD/USD, the MPD or the LCT session delivering the same may be referred to as a service signaling channel. In case of MMTP, the USBD/UD, the MMT signaling message or the packet flow delivering the same may be referred to as a service signaling channel.

Unlike the shown embodiment, one ROUTE or MMTP session may be delivered over a plurality of PLPs. That is, one service may be delivered through one or more PLPs. Unlike the shown embodiment, in some embodiments, components configuring one service may be delivered through different ROUTE sessions. In addition, in some embodiments, components configuring one service may be delivered through different MMTP sessions. In some embodiments, components configuring one service may be divided and delivered in a ROUTE session and an MMTP session. Although not shown, components configuring one service may be delivered through broadband (hybrid delivery).

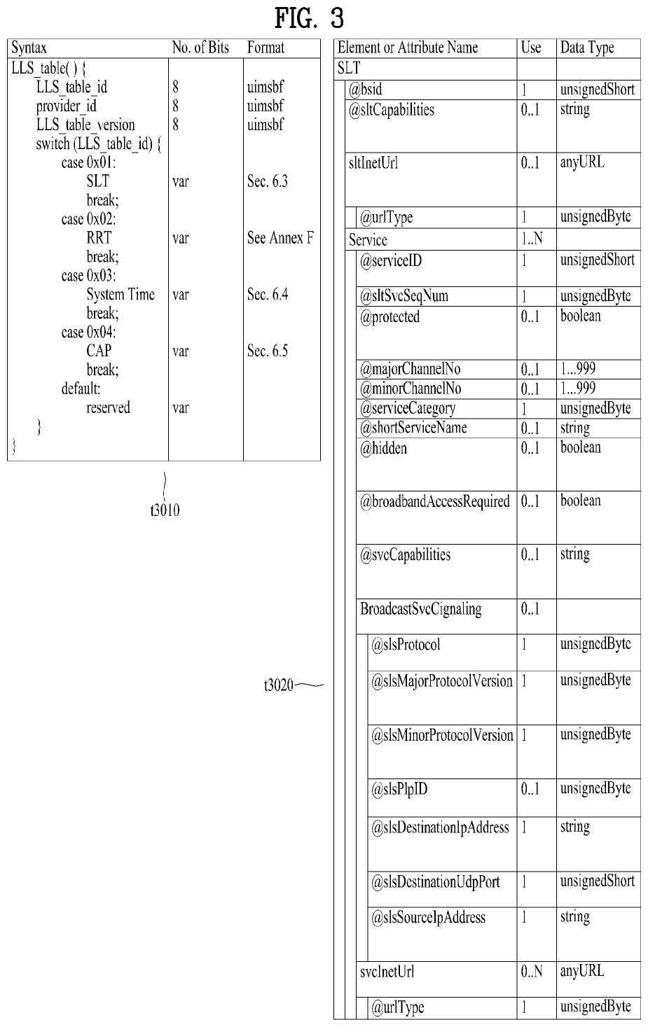

FIG. 3 is a diagram showing a low level signaling (LLS) table and a service list table (SLT) according to one embodiment of the present invention.

One embodiment t3010 of the LLS table may include information according to an LLS_table_id field, a provider_id field, an LLS_table_version field and/or an LLS_table_id field.

The LLS_table_id field may identify the type of the LLS table, and the provider_id field may identify a service provider associated with services signaled by the LLS table. Here, the service provider is a broadcaster using all or some of the broadcast streams and the provider_id field may identify one of a plurality of broadcasters which is using the broadcast streams. The LLS_table_version field may provide the version information of the LLS table.

According to the value of the LLS_table_id field, the LLS table may include one of the above-described SLT, a rating region table (RRT) including information on a content advisory rating, SystemTime information for providing information associated with a system time, a common alert protocol (CAP) message for providing information associated with emergency alert. In some embodiments, the other information may be included in the LLS table.

One embodiment t3020 of the shown SLT may include an @bsid attribute, an @sltCapabilities attribute, an sltInetUrl element and/or a Service element. Each field may be omitted according to the value of the shown Use column or a plurality of fields may be present.

The @bsid attribute may be the identifier of a broadcast stream. The @sltCapabilities attribute may provide capability information required to decode and significantly reproduce all services described in the SLT. The sltInetUrl element may provide base URL information used to obtain service signaling information and ESG for the services of the SLT over broadband. The sltInetUrl element may further include an @urlType attribute, which may indicate the type of data capable of being obtained through the URL.

The Service element may include information on services described in the SLT, and the Service element of each service may be present. The Service element may include an @serviceId attribute, an @sltSvcSeqNum attribute, an @protected attribute, an @majorChannelNo attribute, an @minorChannelNo attribute, an @serviceCategory attribute, an @shortServiceName attribute, an @hidden attribute, an @broadbandAccess Required attribute, an @svcCapabilities attribute, a BroadcastSvcSignaling element and/or an svcInetUrl element.

The @serviceId attribute is the identifier of the service and the @sltSvcSeqNum attribute may indicate the sequence number of the SLT information of the service. The @protected attribute may indicate whether at least one service component necessary for significant reproduction of the service is protected. The @majorChannelNo attribute and the @minorChannelNo attribute may indicate the major channel number and minor channel number of the service, respectively.

The @serviceCategory attribute may indicate the category of the service. The category of the service may include a linear A/V service, a linear audio service, an app based service, an ESG service, an EAS service, etc. The @shortServiceName attribute may provide the short name of the service. The @hidden attribute may indicate whether the service is for testing or proprietary use. The @broadbandAccessRequired attribute may indicate whether broadband access is necessary for significant reproduction of the service. The @svcCapabilities attribute may provide capability information necessary for decoding and significant reproduction of the service.

The BroadcastSvcSignaling element may provide information associated with broadcast signaling of the service. This element may provide information such as location, protocol and address with respect to signaling over the broadcast network of the service. Details thereof will be described below.

The svcInetUrl element may provide URL information for accessing the signaling information of the service over broadband. The sltInetUrl element may further include an @urlType attribute, which may indicate the type of data capable of being obtained through the URL.

The above-described BroadcastSvcSignaling element may include an @slsProtocol attribute, an @slsMajorProtocolVersion attribute, an @slsMinorProtocolVersion attribute, an @slsPlpId attribute, an @slsDestinationIpAddress attribute, an @slsDestinationUdpPort attribute and/or an @slsSourceIpAddress attribute.

The @slsProtocol attribute may indicate the protocol used to deliver the SLS of the service (ROUTE, MMT, etc.). The @slsMajorProtocolVersion attribute and the @slsMinorProtocolVersion attribute may indicate the major version number and minor version number of the protocol used to deliver the SLS of the service, respectively.

The @slsPlpId attribute may provide a PLP identifier for identifying the PLP delivering the SLS of the service. In some embodiments, this field may be omitted and the PLP information delivered by the SLS may be checked using a combination of the information of the below-described LMT and the bootstrap information of the SLT.

The @slsDestinationIpAddress attribute, the @slsDestinationUdpPort attribute and the @slsSourceIpAddress attribute may indicate the destination IP address, destination UDP port and source IP address of the transport packets delivering the SLS of the service, respectively. These may identify the transport session (ROUTE session or MMTP session) delivered by the SLS. These may be included in the bootstrap information.

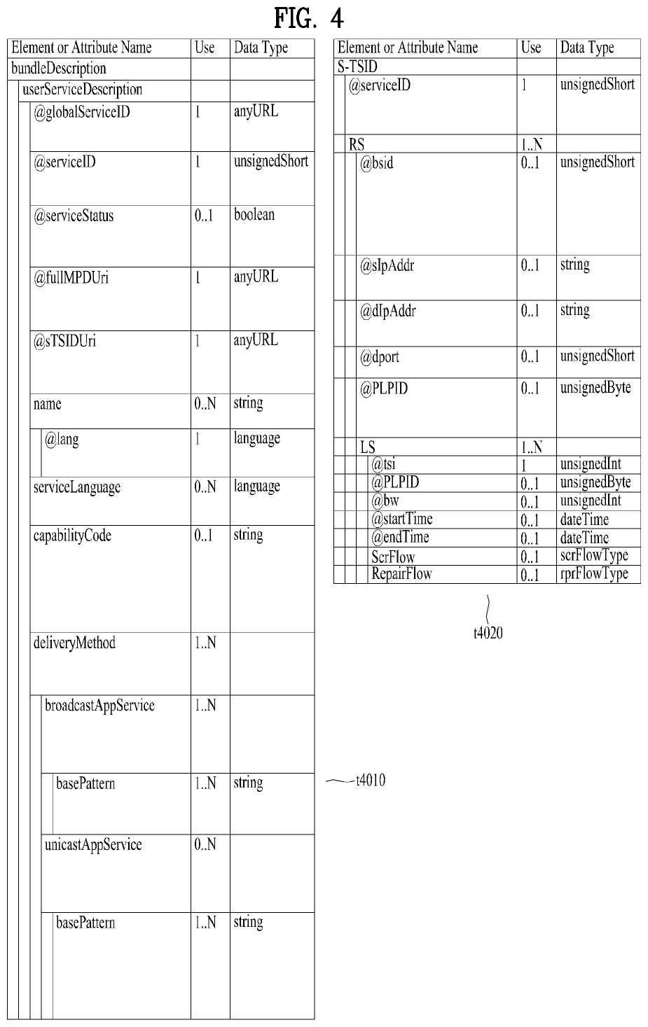

FIG. 4 is a diagram showing a USBD and an S-TSID delivered through ROUTE according to one embodiment of the present invention.

One embodiment t4010 of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, an @serviceStatus attribute, an @fullMPDUri attribute, an @sTSIDUri attribute, a name element, a serviceLanguage element, a capabilityCode element and/or a deliveryMethod element. Each field may be omitted according to the value of the shown Use column or a plurality of fields may be present.

The @globalServiceID attribute is the globally unique identifier of the service and may be used for link with ESG data (Service@globalServiceID). The @serviceId attribute is a reference corresponding to the service entry of the SLT and may be equal to the service ID information of the SLT. The @serviceStatus attribute may indicate the status of the service. This field may indicate whether the service is active or inactive.

The @fullMPDUri attribute may reference the MPD fragment of the service. The MPD may provide a reproduction description of a service component delivered over the broadcast or broadband network as described above. The @sTSIDUri attribute may reference the S-TSID fragment of the service. The S-TSID may provide parameters associated with access to the transport session carrying the service as described above.

The name element may provide the name of the service. This element may further include an @lang attribute and this field may indicate the language of the name provided by the name element. The serviceLanguage element may indicate available languages of the service. That is, this element may arrange the languages capable of being provided by the service.

The capabilityCode element may indicate capability or capability group information of a receiver necessary to significantly reproduce the service. This information is compatible with capability information format provided in service announcement.

The deliveryMethod element may provide transmission related information with respect to content accessed over the broadcast or broadband network of the service. The deliveryMethod element may include a broadcastAppService element and/or a unicastAppService element. Each of these elements may have a basePattern element as a sub element.

The broadcastAppService element may include transmission associated information of the DASH representation delivered over the broadcast network. The DASH representation may include media components over all periods of the service presentation.

The basePattern element of this element may indicate a character pattern used for the receiver to perform matching with the segment URL. This may be used for a DASH client to request the segments of the representation. Matching may imply delivery of the media segment over the broadcast network.

The unicastAppService element may include transmission related information of the DASH representation delivered over broadband. The DASH representation may include media components over all periods of the service media presentation.

The basePattern element of this element may indicate a character pattern used for the receiver to perform matching with the segment URL. This may be used for a DASH client to request the segments of the representation. Matching may imply delivery of the media segment over broadband.

One embodiment t4020 of the shown S-TSID may have an S-TSID root element. The S-TSID root element may include an @serviceId attribute and/or an RS element. Each field may be omitted according to the value of the shown Use column or a plurality of fields may be present.

The @serviceId attribute is the identifier of the service and may reference the service of the USBD/USD. The RS element may describe information on ROUTE sessions through which the service components of the service are delivered. According to the number of ROUTE sessions, a plurality of elements may be present. The RS element may further include an @bsid attribute, an @sIpAddr attribute, an @dIpAddr attribute, an @dport attribute, an @PLPID attribute and/or an LS element.

The @bsid attribute may be the identifier of a broadcast stream in which the service components of the service are delivered. If this field is omitted, a default broadcast stream may be a broadcast stream including the PLP delivering the SLS of the service. The value of this field may be equal to that of the @bsid attribute.

The @sIpAddr attribute, the @dIpAddr attribute and the @dport attribute may indicate the source IP address, destination IP address and destination UDP port of the ROUTE session, respectively. When these fields are omitted, the default values may be the source address, destination IP address and destination UDP port values of the current ROUTE session delivering the SLS, that is, the S-TSID. This field may not be omitted in another ROUTE session delivering the service components of the service, not in the current ROUTE session.

The @PLPID attribute may indicate the PLP ID information of the ROUTE session. If this field is omitted, the default value may be the PLP ID value of the current PLP delivered by the S-TSID. In some embodiments, this field is omitted and the PLP ID information of the ROUTE session may be checked using a combination of the information of the below-described LMT and the IP address/UDP port information of the RS element.

The LS element may describe information on LCT channels through which the service components of the service are transmitted. According to the number of LCT channel, a plurality of elements may be present. The LS element may include an @tsi attribute, an @PLPID attribute, an @bw attribute, an @startTime attribute, an @endTime attribute, a SrcFlow element and/or a RepairFlow element.

The @tsi attribute may indicate the tsi information of the LCT channel. Using this, the LCT channels through which the service components of the service are delivered may be identified. The @PLPID attribute may indicate the PLP ID information of the LCT channel. In some embodiments, this field may be omitted. The @bw attribute may indicate the maximum bandwidth of the LCT channel. The @startTime attribute may indicate the start time of the LCT session and the @endTime attribute may indicate the end time of the LCT channel.

The SrcFlow element may describe the source flow of ROUTE. The source protocol of ROUTE is used to transmit a delivery object and at least one source flow may be established within one ROUTE session. The source flow may deliver associated objects as an object flow.

The RepairFlow element may describe the repair flow of ROUTE. Delivery objects delivered according to the source protocol may be protected according to forward error correction (FEC) and the repair protocol may define an FEC framework enabling FEC protection.

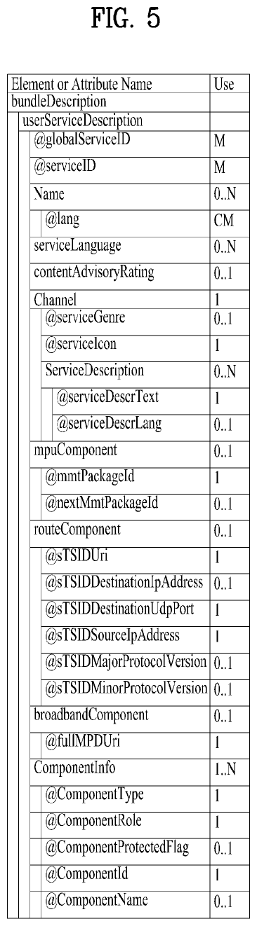

FIG. 5 is a diagram showing a USBD delivered through MMT according to one embodiment of the present invention.

One embodiment of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, a Name element, a serviceLanguage element, a contentAdvisoryRating element, a Channel element, a mpuComponent element, a routeComponent element, a broadbandComponent element and/or a ComponentInfo element. Each field may be omitted according to the value of the shown Use column or a plurality of fields may be present.

The @globalServiceID attribute, the @serviceId attribute, the Name element and/or the serviceLanguage element may be equal to the fields of the USBD delivered through ROUTE. The contentAdvisoryRating element may indicate the content advisory rating of the service. This information is compatible with content advisory rating information format provided in service announcement. The Channel element may include information associated with the service. A detailed description of this element will be given below.

The mpuComponent element may provide a description of service components delivered as the MPU of the service. This element may further include an @mmtPackageId attribute and/or an @nextMmtPackageId attribute. The @mmtPackageId attribute may reference the MMT package of the service components delivered as the MPU of the service. The @nextMmtPackageId attribute may reference an MMT package to be used after the MMT package referenced by the @mmtPackageId attribute in terms of time. Through the information of this element, the MP table may be referenced.

The routeComponent element may include a description of the service components of the service. Even when linear service components are delivered through the MMT protocol, NRT data may be delivered according to the ROUTE protocol as described above. This element may describe information on such NRT data. A detailed description of this element will be given below.

The broadbandComponent element may include the description of the service components of the service delivered over broadband. In hybrid service delivery, some service components of one service or other files may be delivered over broadband. This element may describe information on such data. This element may further an @fullMPDUri attribute. This attribute may reference the MPD describing the service component delivered over broadband. In addition to hybrid service delivery, the broadcast signal may be weakened due to traveling in a tunnel and thus this element may be necessary to support handoff between broadband and broadband. When the broadcast signal is weak, the service component is acquired over broadband and, when the broadcast signal becomes strong, the service component is acquired over the broadcast network to secure service continuity.

The ComponentInfo element may include information on the service components of the service. According to the number of service components of the service, a plurality of elements may be present. This element may describe the type, role, name, identifier or protection of each service component. Detailed information of this element will be described below.

The above-described Channel element may further include an @serviceGenre attribute, an @serviceIcon attribute and/or a ServiceDescription element. The @serviceGenre attribute may indicate the genre of the service and the @serviceIcon attribute may include the URL information of the representative icon of the service. The ServiceDescription element may provide the service description of the service and this element may further include an @serviceDescrText attribute and/or an @serviceDescrLang attribute. These attributes may indicate the text of the service description and the language used in the text.

The above-described routeComponent element may further include an @sTSIDUri attribute, an @sTSIDDestinationIpAddress attribute, an @sTSIDDestinationUdpPort attribute, an @sTSIDSourceIpAddress attribute, an @sTSIDMajorProtocolVersion attribute and/or an @sTSIDMinorProtocolVersion attribute.

The @sTSIDUri attribute may reference an S-TSID fragment. This field may be equal to the field of the USBD delivered through ROUTE. This S-TSID may provide access related information of the service components delivered through ROUTE. This S-TSID may be present for NRT data delivered according to the ROUTE protocol in a state of delivering linear service component according to the MMT protocol.

The @sTSIDDestinationIpAddress attribute, the @sTSIDDestinationUdpPort attribute and the @sTSIDSourceIpAddress attribute may indicate the destination IP address, destination UDP port and source IP address of the transport packets carrying the above-described S-TSID. That is, these fields may identify the transport session (MMTP session or the ROUTE session) carrying the above-described S-TSID.

The @sTSIDMajorProtocolVersion attribute and the @sTSIDMinorProtocolVersion attribute may indicate the major version number and minor version number of the transport protocol used to deliver the above-described S-TSID, respectively.

The above-described ComponentInfo element may further include an @componentType attribute, an @componentRole attribute, an @componentProtectedFlag attribute, an @componentId attribute and/or an @componentName attribute.

The @componentType attribute may indicate the type of the component. For example, this attribute may indicate whether the component is an audio, video or closed caption component. The @componentRole attribute may indicate the role of the component. For example, this attribute may indicate main audio, music, commentary, etc. if the component is an audio component. This attribute may indicate primary video if the component is a video component. This attribute may indicate a normal caption or an easy reader type if the component is a closed caption component.

The @componentProtectedFlag attribute may indicate whether the service component is protected, for example, encrypted. The @componentId attribute may indicate the identifier of the service component. The value of this attribute may be the asset_id (asset ID) of the MP table corresponding to this service component. The @componentName attribute may indicate the name of the service component.

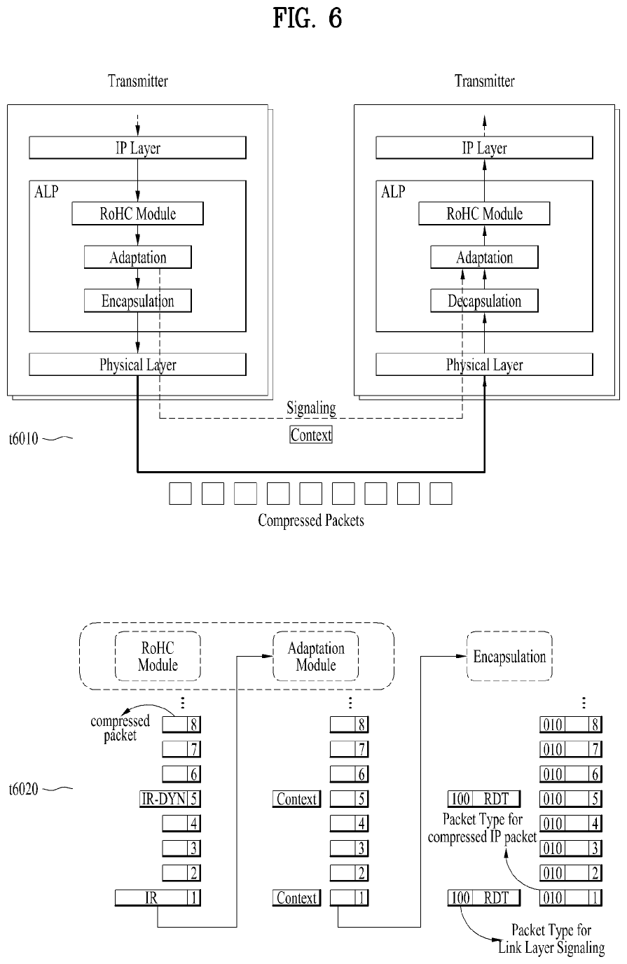

FIG. 6 is a diagram showing link layer operation according to one embodiment of the present invention.

The link layer may be a layer between a physical layer and a network layer. A transmission side may transmit data from the network layer to the physical layer and a reception side may transmit data from the physical layer to the network layer (t6010). The purpose of the link layer is to compress (abstract) all input packet types into one format for processing by the physical layer and to secure flexibility and expandability of an input packet type which is not defined yet. In addition, the link layer may provide option for compressing (abstracting) unnecessary information of the header of input packets to efficiently transmit input data. Operation such as overhead reduction, encapsulation, etc. of the link layer is referred to as a link layer protocol and packets generated using this protocol may be referred to as link layer packets. The link layer may perform functions such as packet encapsulation, overhead reduction and/or signaling transmission.

At the transmission side, the link layer (ALP) may perform an overhead reduction procedure with respect to input packets and then encapsulate the input packets into link layer packets. In addition, in some embodiments, the link layer may perform encapsulation into the link layer packets without performing the overhead reduction procedure. Due to use of the link layer protocol, data transmission overhead on the physical layer may be significantly reduced and the link layer protocol according to the present invention may provide IP overhead reduction and/or MPEG-2 TS overhead reduction.

When the shown IP packets are input as input packets (t6010), the link layer may sequentially perform IP header compression, adaptation and/or encapsulation. In some embodiments, some processes may be omitted. For example, the RoHC module may perform IP packet header compression to reduce unnecessary overhead. Context information may be extracted through the adaptation procedure and transmitted out of band. The IP header compression and adaption procedure may be collectively referred to as IP header compression. Thereafter, the IP packets may be encapsulated into link layer packets through the encapsulation procedure.

When MPEG 2 TS packets are input as input packets, the link layer may sequentially perform overhead reduction and/or an encapsulation procedure with respect to the TS packets. In some embodiments, some procedures may be omitted. In overhead reduction, the link layer may provide sync byte removal, null packet deletion and/or common header removal (compression). Through sync byte removal, overhead reduction of 1 byte may be provided per TS packet. Null packet deletion may be performed in a manner in which reinsertion is possible at the reception side. In addition, deletion (compression) may be performed in a manner in which common information between consecutive headers may be restored at the reception side. Some of the overhead reduction procedures may be omitted. Thereafter, through the encapsulation procedure, the TS packets may be encapsulated into link layer packets. The link layer packet structure for encapsulation of the TS packets may be different from that of the other types of packets.

First, IP header compression will be described.

The IP packets may have a fixed header format but some information necessary for a communication environment may be unnecessary for a broadcast environment. The link layer protocol may compress the header of the IP packet to provide a mechanism for reducing broadcast overhead.

IP header compression may employ a header compressor/decompressor and/or an adaptation module. The IP header compressor (RoHC compressor) may reduce the size of each IP packet header based on the RoHC scheme. Thereafter, the adaptation module may extract context information and generate signaling information from each packet stream. A receiver may parse signaling information associated with the packet stream and attach context information to the packet stream. The RoHC decompressor may restore the packet header to reconfigure an original IP packet. Hereinafter, IP header compression may mean only IP header compression by a header compression or a combination of IP header compression and an adaptation process by an adaptation module. The same is true in decompressing.

Hereinafter, adaptation will be described.

In transmission of a single-direction link, when the receiver does not have context information, the decompressor cannot restore the received packet header until complete context is received. This may lead to channel change delay and turn-on delay. Accordingly, through the adaptation function, configuration parameters and context information between the compressor and the decompressor may be transmitted out of band. The adaptation function may provide construction of link layer signaling using context information and/or configuration parameters. The adaptation function may use previous configuration parameters and/or context information to periodically transmit link layer signaling through each physical frame.

Context information is extracted from the compressed IP packets and various methods may be used according to adaptation mode.

Mode #1 refers to a mode in which no operation is performed with respect to the compressed packet stream and an adaptation module operates as a buffer.

Mode #2 refers to a mode in which an IR packet is detected from a compressed packet stream to extract context information (static chain). After extraction, the IR packet is converted into an IR-DYN packet and the IR-DYN packet may be transmitted in the same order within the packet stream in place of an original IR packet.

Mode #3 (t6020) refers to a mode in which IR and IR-DYN packets are detected from a compressed packet stream to extract context information. A static chain and a dynamic chain may be extracted from the IR packet and a dynamic chain may be extracted from the IR-DYN packet. After extraction, the IR and IR-DYN packets are converted into normal compression packets. The converted packets may be transmitted in the same order within the packet stream in place of original IR and IR-DYN packets.

In each mode, the context information is extracted and the remaining packets may be encapsulated and transmitted according to the link layer packet structure for the compressed IP packets. The context information may be encapsulated and transmitted according to the link layer packet structure for signaling information, as link layer signaling.

The extracted context information may be included in a RoHC-U description table (RDT) and may be transmitted separately from the RoHC packet flow. Context information may be transmitted through a specific physical data path along with other signaling information. The specific physical data path may mean one of normal PLPs, a PLP in which low level signaling (LLS) is delivered, a dedicated PLP or an L1 signaling path. Here, the RDT may be context information (static chain and/or dynamic chain) and/or signaling information including information associated with header compression. In some embodiments, the RDT shall be transmitted whenever the context information is changed. In addition, in some embodiments, the RDT shall be transmitted every physical frame. In order to transmit the RDT every physical frame, the previous RDT may be reused.

The receiver may select a first PLP and first acquire signaling information of the SLT, the RDT, the LMT, etc., prior to acquisition of a packet stream. When signaling information is acquired, the receiver may combine the signaling information to acquire mapping between service-IP information-context information-PLP. That is, the receiver may check which service is transmitted in which IP streams or which IP streams are delivered in which PLP and acquire context information of the PLPs. The receiver may select and decode a PLP carrying a specific packet stream. The adaptation module may parse context information and combine the context information with the compressed packets. To this end, the packet stream may be restored and delivered to the RoHC decompressor. Thereafter, decompression may start. At this time, the receiver may detect IR packets to start decompression from an initially received IR packet (mode 1), detect IR-DYN packets to start decompression from an initially received IR-DYN packet (mode 2) or start decompression from any compressed packet (mode 3).

Hereinafter, packet encapsulation will be described.

The link layer protocol may encapsulate all types of input packets such as IP packets, TS packets, etc. into link layer packets. To this end, the physical layer processes only one packet format independently of the protocol type of the network layer (here, an MPEG-2 TS packet is considered as a network layer packet). Each network layer packet or input packet is modified into the payload of a generic link layer packet.

In the packet encapsulation procedure, segmentation may be used. If the network layer packet is too large to be processed in the physical layer, the network layer packet may be segmented into two or more segments. The link layer packet header may include fields for segmentation of the transmission side and recombination of the reception side. Each segment may be encapsulated into the link layer packet in the same order as the original location.

In the packet encapsulation procedure, concatenation may also be used. If the network layer packet is sufficiently small such that the payload of the link layer packet includes several network layer packets, concatenation may be performed. The link layer packet header may include fields for performing concatenation. In concatenation, the input packets may be encapsulated into the payload of the link layer packet in the same order as the original input order.

The link layer packet may include a header and a payload. The header may include a base header, an additional header and/or an optional header. The additional header may be further added according to situation such as concatenation or segmentation and the additional header may include fields suitable for situations. In addition, for delivery of the additional information, the optional header may be further included. Each header structure may be pre-defined. As described above, if the input packets are TS packets, a link layer header having packets different from the other packets may be used.

Hereinafter, link layer signaling will be described.

Link layer signaling may operate at a level lower than that of the IP layer. The reception side may acquire link layer signaling faster than IP level signaling of the LLS, the SLT, the SLS, etc. Accordingly, link layer signaling may be acquired before session establishment.

Link layer signaling may include internal link layer signaling and external link layer signaling. Internal link layer signaling may be signaling information generated at the link layer. This includes the above-described RDT or the below-described LMT. External link layer signaling may be signaling information received from an external module, an external protocol or a higher layer. The link layer may encapsulate link layer signaling into a link layer packet and deliver the link layer packet. A link layer packet structure (header structure) for link layer signaling may be defined and link layer signaling information may be encapsulated according to this structure.

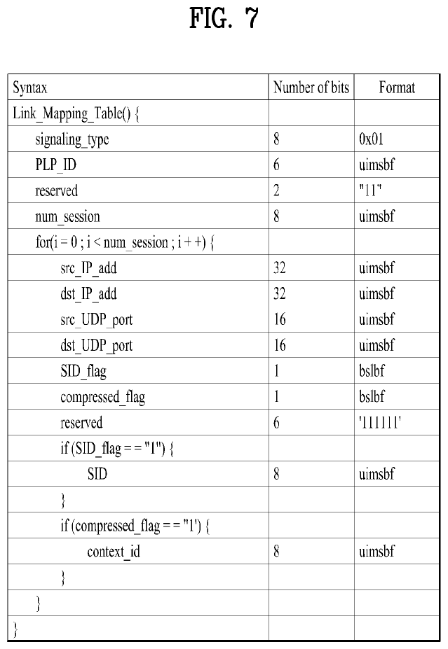

FIG. 7 is a diagram showing a link mapping table (LMT) according to one embodiment of the present invention.

The LMT may provide a list of higher layer sessions carried through the PLP. In addition, the LMT may provide additional information for processing link layer packets carrying the higher layer sessions. Here, the higher layer sessions may be called multicast. Information on IP streams or transport sessions transmitted through a specific PLP may be acquired through the LMT. In contrast, information on through which PLP a specific transport session is delivered may be acquired.

The LMT can be delivered through any PLP which is identified as carrying LLS. Here, a PLP through which LLS is delivered can be identified by an LLS flag of L1 detail signaling information of the physical layer. The LLS flag may be a flag field indicating whether LLS is delivered through a corresponding PLP for each PLP. Here, the L1 detail signaling information may correspond to PLS2 data which will be described below.

That is, the LMT can be delivered along with the LLS through the same PLP. Each LMT can describe mapping between PLPs and IP addresses/ports as described above. The LLS may include an SLT, as described abo e. An IP address/port described by the LMT may be any IP address/port related to any service described by the SLT delivered through the same PLP as that used to deliver the LMT.

In some embodiments, the PLP identifier information in the above-described SLT, SLS, etc. may be used to confirm information indicating through which PLP a specific transport session indicated by the SLT or SLS is transmitted may be confirmed.

In another embodiment, the PLP identifier information in the above-described SLT, SLS, etc. will be omitted and PLP information of the specific transport session indicated by the SLT or SLS may be confirmed by referring to the information in the LMT. In this case, the receiver may combine the LMT and other IP level signaling information to identify the PLP. Even in this embodiment, the PLP information in the SLT, SLS, etc. is not omitted and may remain in the SLT, SLS, etc.

The LMT according to the shown embodiment may include a signaling_type field, a PLP_ID field, a num_session field and/or information on each session. Although the LMT of the shown embodiment describes IP streams transmitted through one PLP, a PLP loop may be added to the LMT to describe information on a plurality of PLPs in some embodiments.

The signaling_type field may indicate the type of signaling information delivered by the table. The value of signaling_type field for the LMT may be set to 0x01. The signaling_type field may be omitted. The PLP_ID field may identify a PLP which is a target to be described. When a PLP loop is used, each PLP_ID field can identify each target PLP. The PLP_ID field and following fields may be included in a PLP loop. The PLP_ID field which will be mentioned below is an ID of one PLP in a PLP loop and fields which will be described below may be fields with respect to the corresponding PLP.

The num_session field may indicate the number of higher layer sessions delivered through the PLP identified by the corresponding PLP_ID field. According to the number indicated by the num_session field, information on each session may be included. This information may include a src_IP_add field, a dst_IP_add field, a src_UDP_port field, a dst_UDP_port field, an SID_flag field, a compressed_flag field, an SID field and/or a context_id field.

The src_IP_add field, the dst_IP_add field, the src_UDP_port field and the dst_UDP_port field may indicate the source IP address, the destination IP address, the source UDP port and the destination UDP port of the transport session among the higher layer sessions delivered through the PLP identified by the corresponding PLP_ID field.

The SID_flag field may indicate whether the link layer packet delivering the transport session has an SID field in the optional header. The link layer packet delivering the higher layer session may have an SID field in the optional header and the SID field value may be equal to that of the SID field in the LMT.

The compressed_flag field may indicate whether header compression is applied to the data of the link layer packet delivering the transport session. In addition, presence/absence of the below-described context_id field may be determined according to the value of this field. When header compression is applied (compressed_field=1), an RDT can be present and a PLP ID field of the RDT can have the same value as the PLP_ID field related to the compressed_flag field.

The SID field may indicate the SIDs (sub stream IDs) of the link layer packets delivering the transport session. The link layer packets may include an SID having the same values as the SID field in the optional headers thereof. Accordingly, the receiver can filter link layer packets using information of the LMT and SID information of link layer packet headers without parsing all of the link layer packets.

The context_id field may provide a reference for a context id (CID) in the RDT. The CID information of the RDT may indicate the context ID of the compression IP packet stream. The RDT may provide context information of the compression IP packet stream. Through this field, the RDT and the LMT may be associated.

In the above-described embodiments of the signaling information/table of the present invention, the fields, elements or attributes may be omitted or may be replaced with other fields. In some embodiments, additional fields, elements or attributes may be added.

In one embodiment of the present invention, service components of a service can be delivered through a plurality of ROUTE sessions. In this case, the SLS can be acquired through bootstrap information of an SLT. S-TSID and MPD can be referenced through USBD of the SLS. The S-TSID can describe not only a ROUTE session through which the SLS is delivered but also transport session description information about other ROUTE sessions through which the service components are delivered. Accordingly, all the service components delivered through the multiple ROUTE sessions can be collected. This can be equally applied to a case in which service components of a service are delivered through a plurality of MMTP sessions. For reference, one service component may be simultaneously used by multiple services.

In another embodiment of the present invention, bootstrapping for an ESG service can be performed through a broadcast network or a broadband. URL information of an SLT can be used by acquiring an ESG through a broadband. A request for ESG information may be sent to the URL.

In another embodiment of the present invention, one of the service components of a service can be delivered through a broadcast network and another service component may be delivered over a broadband (hybrid). The S-TSID describes components delivered over a broadcast network such that a ROUTE client can acquire desired service components. In addition, the USBD has base pattern information and thus can describe which segments (which components) are delivered and paths through which the segments are delivered. Accordingly, a receiver can recognize segments that need to be requested from a broadband server and segments that need to be detected from broadcast streams using the USBD.

In another embodiment of the present invention, scalable coding for a service can be performed. The USBD may have all pieces of capability information necessary to render the corresponding service. For example, when a HD or UHD service is provided, the capability information of the USBD may have a value of “HD UHD”. The receiver can recognize which component needs to be presented to render a UHD or HD service using the MPD.

In another embodiment of the present invention, SLS fragments delivered (USBD, S-TSID, MPD or the like) by LCT packets delivered through an LCT channel which delivers the SLS can be identified through a TOI field of the LCT packets.

In another embodiment of the present invention, application components to be used for application based enhancement/app based service can be delivered over a broadcast network or a broadband as NRT components. In addition, application signaling for application based enhancement can be performed by an AST (Application Signaling Table) delivered along with the SLS. Further, an event which is signaling for an operation to be executed by an application may be delivered in the form of an EMT (Event Message Table) along with the SLS, signaled in MPD, or in-band signaled in the form of a box in DASH representation. The AST and the EMT may be delivered over a broadband. Application based enhancement can be provided using collected application components and the aforementioned signaling information.

In another embodiment of the present invention, a CAP message may be included in the aforementioned LLS table and provided for emergency alert. Rich media content for emergency alert may also be provided. Rich media may be signaled through a CAP message. When rich media are present, the rich media can be provided as an EAS service signaled through an SLT.

In another embodiment of the present invention, linear service components can be delivered through a broadcast network according to the MMT protocol. In this case, NRT data (e.g., application component) regarding the corresponding service can be delivered through a broadcast network according to the ROUTE protocol. In addition, data regarding the corresponding service may be delivered over a broadband. The receiver can access an MMTP session through which the SLS is delivered using bootstrap information of the SLT. The USBD of the SLS according to the MMT can reference an MP table to allow the receiver to acquire linear service components formatted into MPU and delivered according to the MMT protocol. Furthermore, the USBD can further reference S-TSID to allow the receiver to acquire NRT data delivered according to the ROUTE protocol. Moreover, the USBD can further reference the MPD to provide reproduction description for data delivered over a broadband.

In another embodiment of the present invention, the receiver can deliver location URL information through which streaming components and/or file content items (files, etc.) can be acquired to a companion device thereof through a method such as web socket. An application of the companion device can acquire corresponding component data by sending a request to the URL through HTTP GET. In addition, the receiver can deliver information such as system time information and emergency alert information to the companion device.

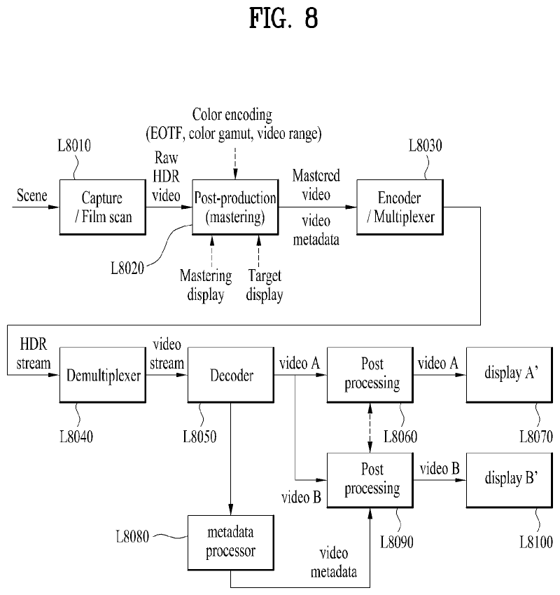

FIG. 8 is a view showing the structure of a broadcast signal transmission and reception system according to an embodiment of the present invention.

A broadcasting system according to an embodiment of the present invention may provide a method of signaling a video format for a plurality of video outputs. In the case in which a codec that supports a plurality of video outputs is used, a broadcasting system according to an embodiment of the present invention may signal a format for each video output. In other words, a broadcasting system according to an embodiment of the present invention may signal the format features of one or more different video outputs.

A broadcasting system according to an embodiment of the present invention may provide a method of describing video outputs having different features that are generated from a video sequence. In an embodiment of the present invention, signaled video features may include a transfer function applied to video, colorimetry (a color gamut), a color conversion matrix, a video range, chroma sub-sampling, a bit depth, RGB, and YCbCr. A broadcasting system according to an embodiment of the present invention may provide information defined in VUI (video usability information) as video features. A broadcasting system according to an embodiment of the present invention may deliver a plurality of VUI.

An embodiment of the present invention relates to technology related to broadcast service that supports video outputs having different features. An embodiment of the present invention provides a method of signaling the features of a plurality of video outputs that are generated from a video stream. Consequently, a receiver according to an embodiment of the present invention may identify the features of each video output. Furthermore, the receiver may output each video signal, and may perform additional processing in order to improve video quality.

This figure shows the structure of a broadcasting system according to an embodiment of the present invention. A broadcasting system according to an embodiment of the present invention includes a capture/film scan unit L8010, a post-production (mastering) unit L8020, an encoder/multiplexer L8030, a demultiplexer L8040, a decoder L8050, a first post-processing unit L8060, a display A′ L8070, a metadata processor L8080, a second post-processing unit L8090, and/or a display B′ L8100. The capture/film scan unit L8010 captures and scans scenes to generate raw HDR video. The post-production (mastering) unit L8020 masters the HDR video to generate mastered video and video metadata for signaling the features of the mastered video. Color encoding information (an EOTF, a color gamut, and a video range), information about a mastering display, and information about a target display may be used in order to master the HDR video. The encoder/multiplexer L8030 encodes the mastered video to generate a video stream and performs multiplexing with another stream to generate an HDR stream. The demultiplexer L8040 receives and demultiplexes the HDR stream to generate a video stream. The decoder L8050 decodes the video stream to output video A, video B, and metadata. The metadata processor L8080 receives the metadata, and delivers video metadata, among the metadata, to the second post-processing unit. The first post-processing unit receives and processes the video A and outputs the processed video A to the display A′. The second post-processing unit receives and processes the video B and the video metadata and outputs the processed video A and the processed video metadata to the display B′. The display A′ displays the post-processed video A. The display B′ displays the post-processed video B. At this time, the video A and the video B have different video features.

A broadcasting system according to an embodiment of the present invention provides a method of, in an environment in which only one video stream is transmitted to a reception end, outputting a plurality of videos having individual features using information, a description of which will follow, included in SPS, VPS, and/or PPS in the video stream.

A broadcasting system according to an embodiment of the present invention may include relevant signaling information in SPS, VPS, and/or PPS to output a plurality of videos having individual features without additional post-processing after decoding. That is, this embodiment, in which the output of the decoder is itself a plurality of video outputs, is different from the operation in which one piece of video data output from the decoder undergoes post-processing in order to generate video data having individual features. That is, a broadcasting system according to an embodiment of the present invention may provide a plurality of video outputs having individual features at the decoding level without post-processing.

In an embodiment of the present invention, defining signaling information in SPS, VPS, and/or PPS means that, when video is encoded, the signaling information is essentially used and thus means that the encoded video is changed by the signaling information, unlike defining signaling information in SEI and/or VUI. Consequently, the decoder may decode video transmitted thereto only in the case in which signaling information is defined in SPS, VPS, and/or PPS. Without this information, decoding may be impossible.

A sequence of SPS (sequence parameter set) according to an embodiment of the present invention means a set of pictures. For example, in the case in which one video stream includes a base layer and an enhancement layer, each layer may correspond to one sequence. At this time, video of VPS (video parameter set) may indicate a video stream including a base layer and an enhancement layer.

Signaling information, a description of which will follow, according to an embodiment of the present invention may be signaled while being included in VPS, SPS, PPS, an SEI message, or VUI. Here, the SEI message and VUI include information that is used at the time of post-processing, which is performed after decoding. That is, decoding of a video stream is performed without any problem even though no information is included in the SEI message or VUI. Consequently, information included in the SEI message and VUI may be incidental on video output. However, VPS, SPS, and PPS include information/parameters that are used when video is encoded. That is, information necessary for decoding, e.g. information defining codec parameters, is included. If no information is included in VPS, SPS, or PPS, therefore, it not possible to decode a video stream. For this reason, this information is essential in order to output video. In other words, VUI is information indicating the features of output after decoding, and VPS, SPS, and PPS are information used to decode a video stream in order to generate a complete image. Consequently, a transmission end may efficiently encode a video signal using information included in VPS, SPS, and PPS, and a reception end may decode a complete image in the case in which information is included in VPS, SPS, and PPS, signaled by a codec end.

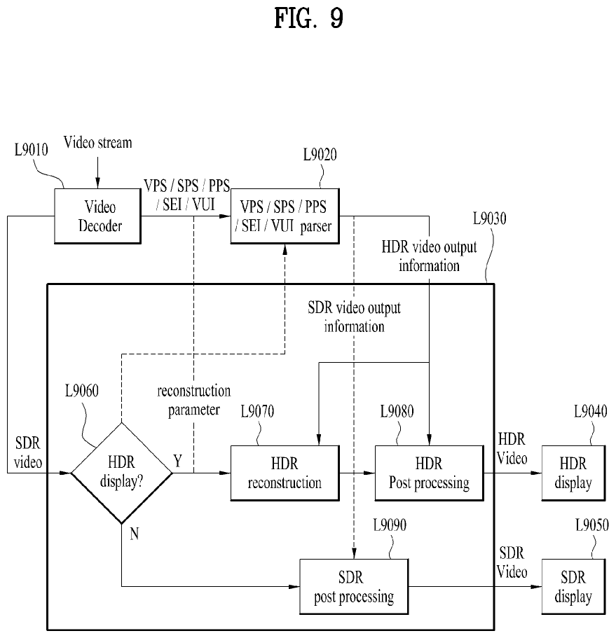

FIG. 9 is a view showing the structure of a broadcast signal reception apparatus according to an embodiment of the present invention.

In this specification, a description will be given mainly based on the operation of a receiver to which the present invention is applied. However, signaling information enabling the operation of the receiver may also be applied to a transmitter, and this signaling information may also be applied to a production process and/or a mastering process.

A broadcast signal reception apparatus according to an embodiment of the present invention may receive a single video stream and output a plurality of videos. Referring to this figure, the broadcast signal reception apparatus receives a single video stream and outputs SDR video and HDR video.

In an embodiment of the present invention, a decoder of the broadcast signal reception apparatus may output video appropriate to be reproduced by an SDR receiver, and the broadcast signal reception apparatus may output video appropriate to be reproduced by an HDR receiver through additional processing (HDR reconstruction). In an embodiment of the present invention, this figure shows the case in which two videos (HDR video and SDR video) are output. Alternatively, a broadcast signal reception apparatus according to an embodiment of the present invention may output two or more videos.

A broadcast signal reception apparatus according to an embodiment of the present invention includes a video decoder L9010, a metadata parser (VPS/SPS/PPS/SEI/VUI parser) L9020, a post-processing unit L9030, an HDR display L9040, and/or an SDR display L9050. The post-processing unit L9030 includes an HDR display determination unit L9060, an HDR reconstruction unit L9070, an HDR post-processing unit L9080, and/or an SDR post-processing unit L9090. The respective units correspond to hardware processor devices that are independently operated in the broadcast signal reception apparatus.

A video decoder according to an embodiment of the present invention decodes a video stream, outputs SDR video, acquired from the video stream, to the post-processing unit, and outputs VPS, SPS, PPS, an SEI message, and/or VUI, acquired from the video stream, to the metadata parser.

A metadata parser according to an embodiment of the present invention analyzes VPS, SPS, PPS, an SEI message, and/or VUI. The metadata parser may identify the video features of SDR video and HDR video through the analyzed VPS, SPS, PPS, SEI message, and/or VUI. The video features may include a transfer function applied to video, colorimetry (a color gamut), a color conversion matrix, a video range, chroma sub-sampling, a bit depth, RGB, and YCbCr.

An HDR display determination unit according to an embodiment of the present invention determines whether the display of the receiver supports HDR. Upon determining that the display of the receiver is a display of an SDR receiver, which does not support HDR, the HDR display determination unit delivers the determination result to the metadata parser. The metadata parser confirms that the value of an sps_multi_output_extension_flag in SPS is 1, and delivers SDR video output information to the SDR post-processing unit through a vui_parameters descriptor. Upon determining that the display of the receiver is a display of an HDR receiver, which supports HDR, the HDR display determination unit delivers the determination result to the metadata parser. The metadata parser confirms that the value of the sps_multi_output_extension_flag in SPS is 1, delivers a reconstruction parameter to the HDR reconstruction unit, and delivers HDR video output information to the HDR post-processing unit through an sps_multi_output_extension descriptor. Alternatively, the metadata parser may deliver all VUI to the HDR post-processing unit. The HDR video output information may include a transfer function applied to video, colorimetry (a color gamut), a color conversion matrix, a video range, chroma sub-sampling, a bit depth, RGB, and YCbCr. The HDR video output information may be directly defined in SPS for each output video.

An SDR post-processing unit according to an embodiment of the present invention identifies a final image format based on a video parameter delivered through basic VUI and performs SDR post-processing using the video parameter. Here, the video parameter may indicate the same information as the SDR video output information.

An HDR reconstruction unit according to an embodiment of the present invention reconstructs SDR video into HDR video using a reconstruction parameter.

An HDR post-processing unit according to an embodiment of the present invention performs HDR post-processing using a video parameter delivered through an sps_output_extension descriptor. Here, the video parameter may indicate the same information as the HDR video output information.

An SDR display according to an embodiment of the present invention displays final SDR video that has undergone the SDR post-processing, and an HDR display according to an embodiment of the present invention displays final HDR video that has undergone the HDR post-processing.

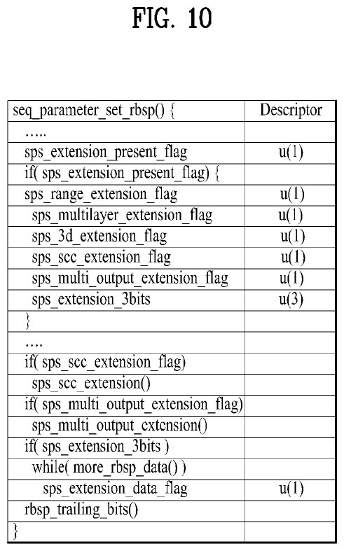

FIG. 10 is a view showing the syntax of SPS (sequence parameter set) RBSP (raw byte sequence payload) according to an embodiment of the present invention.

In the case in which different video outputs are generated, a broadcasting system according to an embodiment of the present invention may define feature information of output video in VPS (video parameter set), which indicates the overall features of video, SPS (sequence parameter set), which indicates the overall features of a sequence, PPS (picture parameter set), which indicates the features of each frame, VUI (video usability information), which indicates the features of output video, and/or an SEI (supplemental enhancement information) message. In an embodiment of the present invention, the position at which feature information of output video is included may be determined depending on the purpose of use of the information. For example, in the case in which feature information of output video is defined in VPS, the information may be applied to all video sequences constituting video service. In the case in which feature information of output video is defined in SPS or VUI, the information may be applied to all frames in the video sequence. In the case in which feature information of output video is defined in PPS, the information may be applied to the frame. In the case in which feature information of output video is changed every frame, therefore, the information may be defined in PPS. In the case in which feature information of output video is defined in an SEI message, the information may be applied to one frame or all sequences.

This figure shows an embodiment in which feature information of output video is delivered through SPS and in which the information affects all sequences. Feature information of output video has a fixed value in all sequences. An embodiment that will be described with reference to this figure relates to a signaling method in the case in which feature information of output video is included in SPS. The same signaling method may also be applied to the case in which feature information of output video is included in VPS and/or PPS.

SPS RBSP according to an embodiment of the present invention includes an sps_extension_present_flag field, an sps_range_extension_flag field, an sps_multilayer_extension_flag field, an sps_3d_extension_flag field, an sps_scc_extension_flag field, an sps_multi_output_extension_flag field, an sps_extension_3bits field, an sps_scc_extension descriptor, an sps_multi_output_extension descriptor (sps_multi_output_extension( )), an sps_extension_data_flag field, and/or an rbsp_trailing_bits descriptor.

The sps_multi_output_extension_flag field indicates whether extended information about the feature of output video exists in the SPS. When the value of this field is 1, this indicates that extended information about the feature of output video exists in the SPS.

The sps_multi_output_extension descriptor will be described in detail with reference to the following figure.

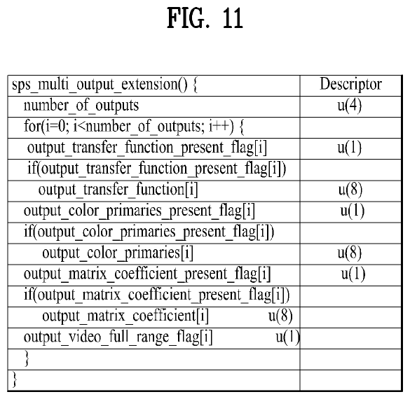

FIG. 11 is a view showing the syntax of an sps_multi_output_extension descriptor according to an embodiment of the present invention.

In an embodiment of the present invention, when a plurality of output videos is generated, feature differences exist between the output videos. At this time, differences in a transfer function applied to each output video, colorimetry (a color gamut), a color conversion matrix, a video range, chroma sub-sampling, a bit depth, RGB, and YCbCr may exist between the output videos.

An sps_multi_output_extension descriptor according to an embodiment of the present invention includes a number_of_outputs field, an output_transfer_function_present_flag field, an output_transfer_function field, an output_color_primaries_present_flag field, an output_color_primaries field, an output_matrix_coefficient_present_flag field, an output_matrix_coefficient field, and/or an output_video_full_range_flag field.

The number_of_outputs field indicates the number of output videos. In an embodiment of the present invention, this field indicates the number of output videos, each of which provides feature information. A broadcasting system according to an embodiment of the present invention may provide necessary information based on each video output using this field.

The output_transfer_function_present_flag field indicates whether an output_transfer_funtion field exists in this descriptor. When the value of this field is 1, this indicates that an output_transfer_funtion field exists in this descriptor.

The output_color_primaries_present_flag field indicates whether an output_color_primaries field exists in this descriptor. When the value of this field is 1, this indicates that an output_color_primaries field exists in this descriptor.

The output_matrix_coefficient_present_flag field indicates whether an output_matrix_coefficient field exists in this descriptor. When the value of this field is 1, this indicates that an output_matrix_coefficient field exists in this descriptor.

The output_transfer_function field indicates the type of transfer function applied to output video. In an embodiment of the present invention, the transfer function indicated by this field may include a transfer function for EOTF/OETF transfer. In another embodiment of the present invention, this field may include a parameter related to a transfer function applied to output video. In an embodiment of the present invention, when the value of this field is 0, this indicates that an EOTF function according to BT. 709 is applied to output video. When the value of this field is 1, this indicates that an EOTF function according to BT. 2020 is applied to output video. When the value of this field is 2, this indicates that an EOTF function according to ARIB ST-B67 is applied to output video. When the value of this field is 3, this indicates that an EOTF function according to SMPTE ST 2084 is applied to output video.

The output_color_primaries field indicates the color gamut of output video. In this specification, the term “color gamut” has the same meaning as colorimetry. When the value of this field is 0, this indicates that a color gamut according to BT. 709 is applied to output video. When the value of this field is 1, this indicates that a color gamut according to BT. 2020 is applied to output video. When the value of this field is 3, this indicates that a color gamut according to DCI-P3 is applied to output video. When the value of this field is 4, this indicates that a color gamut according to Adobe RGB is applied to output video.

The output_matrix_coefficient field indicates information about the color space of output video. In another embodiment of the present invention, this field may indicate information about an equation for converting the color space of output video. In an embodiment of the present invention, when the value of this field is 0, this indicates that the color space of output video is a color space according to an Identity matrix (RGB). When the value of this field is 1, this indicates that the color space of output video is a color space according to XYZ. When the value of this field is 2, this indicates that the color space of output video is a color space according to BT. 709 YCbCr. When the value of this field is 3, this indicates that the color space of output video is a color space according to BT. 2020 YCbCr.

The output_video_full_range_flag field may be used to indicate whether data values of output video are defined within a digital representation range or to indicate whether free space remains even after data values of output video are defined within the digital representation range.

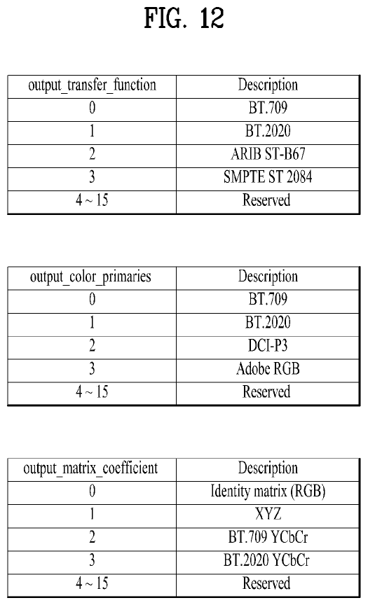

FIG. 12 is a view showing the description of values indicated by an output_transfer_function field, an output_color_primaries field, and an output_matrix_coefficient field according to an embodiment of the present invention.

A detailed description of this figure corresponds to the description of the previous figure.

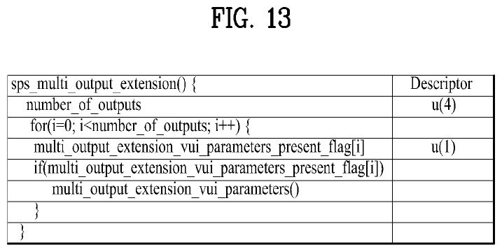

FIG. 13 is a view showing the syntax of an sps_multi_output_extension descriptor according to another embodiment of the present invention.

A broadcasting system according to an embodiment of the present invention may define VUI itself in an sps_multi_output_extension descriptor in order to represent the features of output video supported by a codec.

An sps_multi_output_extension descriptor according to an embodiment of the present invention includes a number_of_outputs field, a multi_output_extension_vui_parameters_present_flag field, and/or a multi_output_extension_vui_parameters descriptor (multi_output_extension_vui_parameters( ). The number_of_outputs field was described previously.

The multi_output_extension_vui_parameters_present_flag field indicates whether a multi_output_extension_vui_parameters descriptor exists in this descriptor. That is, this field indicates whether information about a plurality of output videos is delivered through respective VUI information. When the value of this field is 1, this indicates that VUI information about i-th video output exists in this descriptor.

The multi_output_extension_vui_parameters descriptor will be described with reference to the following figure.

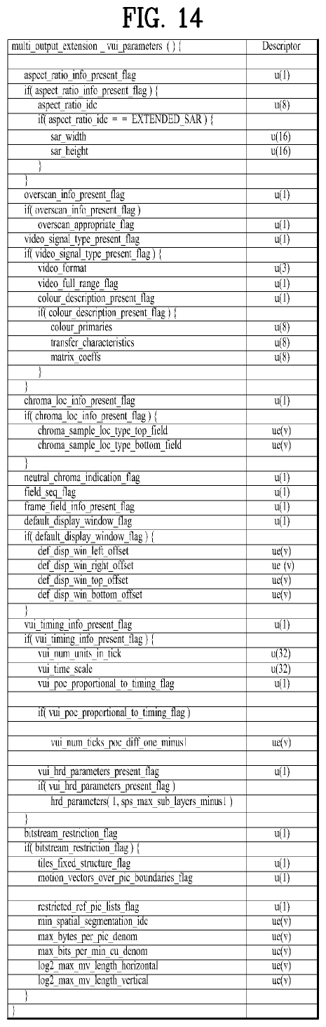

FIG. 14 is a view showing the syntax of a multi_output_extension_vui_parameters descriptor according to an embodiment of the present invention.

A broadcasting system according to an embodiment of the present invention may separately define VUI information about the video output, as shown in this figure. Alternatively, the broadcasting system may use an existing VUI message as a multi_output_extension_vui_parameters descriptor without any change.

VUI information defined according to an embodiment of the present invention may have the same syntax as the syntax of an existing VUI message. The reason for this is that, even though VUI information about additional output video is separately defined, it is necessary to deliver the same information as an existing VUI message about basic output video.

A multi_output_extension_vui_parameters descriptor according to an embodiment of the present invention includes a colour_primaries field, a transfer_characteristics field, a matrix_coeffs field, and/or a video_full_range_flag field. The colour_primaries field may be used as a field having the same meaning as the output_color_primaries field described above. The transfer_characteristics field may be used as a field having the same meaning as the output_transfer_function field described above. The matrix_coeffs field may be used as a field having the same meaning as the output_matrix_coefficient field described above. The video_full_range_flag field may be used as a field having the same meaning as the output_video_full_range_flag field described above.

A description of the other fields included in this descriptor follows the description defined in existing codec standards.

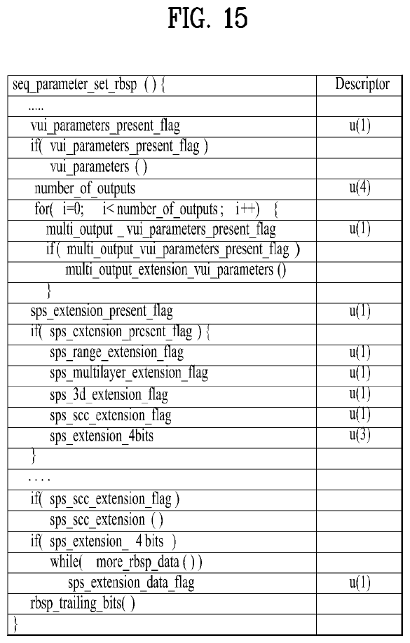

FIG. 15 is a view showing the syntax of SPS (sequence parameter set) RBSP (raw byte sequence payload) according to another embodiment of the present invention.

SPS RBSP according to another embodiment of the present invention may include a number_of_outputs field, a multi_output_vui_parameters_present_flag field, and/or a multi_output_extension_vui_parameters descriptor. A detailed description of the above fields is substituted by the description of the above-described fields having the same names.

In this embodiment, when a plurality of videos is output, VUI information about each video output may be directly signaled in SPS RBSP. Therefore, SPS RBSP according to this embodiment may not include the sps_multi_output_extension_flag field and/or the sps_multi_output_extension descriptor included in the previous embodiment.

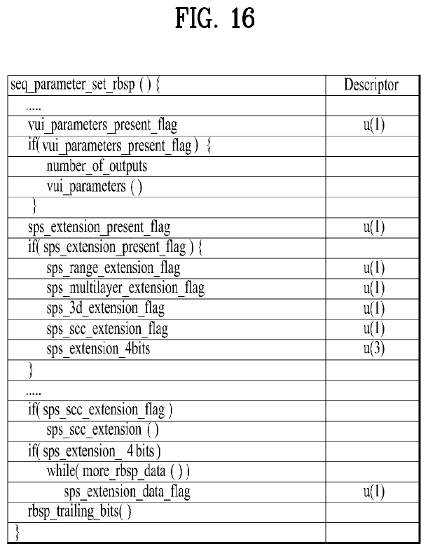

FIG. 16 is a view showing the syntax of SPS (sequence parameter set) RBSP (raw byte sequence payload) according to another embodiment of the present invention.

SPS RBSP according to another embodiment of the present invention may include a vui_parameters_present_flag field, a number_of_outputs field, and/or a vui_parameters descriptor. A detailed description of the above fields is substituted by the description of the above-described fields having the same names.

SPS RBSP according to this embodiment may signal a number of vui_parameters descriptors corresponding to the number of video outputs. Therefore, SPS RBSP according to this embodiment may not include the multi_output_vui_parameters_present_flag field and/or the multi_output_extension_vui_parameters descriptor included in the embodiment described with reference to the previous figure.

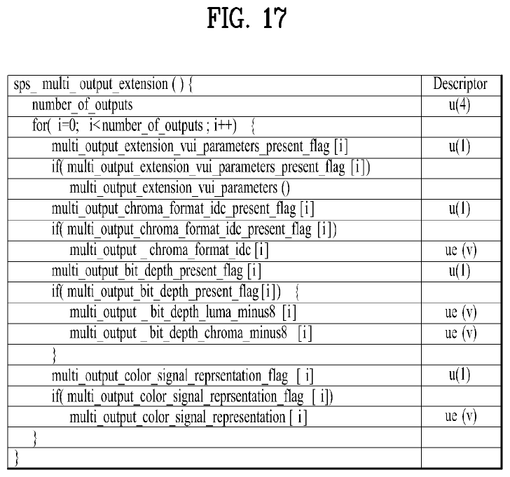

FIG. 17 is a view showing the syntax of an sps_multi_output_extension descriptor according to another embodiment of the present invention.

An sps_multi_output_extension descriptor according to another embodiment of the present invention may include VUI itself about each output video, and at the same time may include information about chroma sub-sampling and/or the bit depth of each output video.

In this embodiment, VUI itself and information about chroma sub-sampling and/or a bit depth are defined in the sps_multi_output_extension descriptor. An sps_multi_output_extension descriptor according to another embodiment of the present invention may define feature information of output video other than the chroma sub-sampling or the bit depth in this descriptor together with VUI itself.

An sps_multi_output_extension descriptor according to another embodiment of the present invention may include a number_of_outputs field, a multi_output_extension_vui_parameters_present_flag field, a multi_output_extension_vui_parameters descriptor (multi_output_extension_vui_parameters, a multi_output_chroma_format_idc_present_flag field, a multi_output_chroma_format_idc field, a multi_output_bit_depth_present_flag field, a multi_output_bit_depth_luma_minus8 field, a multi_output_bit_depth_chroma_minus8 field, a multi_output_color_signal_representation_flag field, and/or a multi_output_color_signal_representation field.

The multi_output_chroma_format_idc_present_flag field indicates whether a multi_output_chroma_format_idc field exists in this descriptor. When the value of this field is 1, this indicates that chroma sub-sampling information about i-th output video exists in this descriptor. In an embodiment of the present invention, when the value of this field is 0, this value may be set as a default value. For example, when the value of this field is 0, this may indicate that chroma sub-sampling information about i-th output video follows the value of a chroma_format_idc field included in SPS RBSP, or may indicate that chroma sub-sampling information about i-th output video is 4:2:0.

The multi_output_chroma_format_idc field indicates chroma sub-sampling information of output video. When the value of this field is 0, this indicates that the chroma sub-sampling value of output video is monochrome. When the value of this field is 1, this indicates that the chroma sub-sampling value of output video is 4:2:0. When the value of this field is 2, this indicates that the chroma sub-sampling value of output video is 4:2:2. When the value of this field is 3, this indicates that the chroma sub-sampling value of output video is 4:4:4.

The multi_output_bit_depth_present_flag field indicates whether a multi_output_bit_depth_luma_minus8 field and/or a multi_output_bit_depth_chroma_minus8 field exist in this descriptor. When the value of this field is 1, this indicates that bit depth information about i-th output video exists. In an embodiment of the present invention, when the value of this field is 0, this value may be set as a default value. For example, when the value of this field is 0, this may indicate that bit depth information about i-th output video follows the values of a bit_depth_luma_minus8 field and/or a depth_chroma_minus8 field included in SPS RBSP, or may indicate that bit depth information about i-th output video is 10 bits.

The multi_output_bit_depth_luma_minus8 field and the multi_output_bit_depth_chroma_minus8 field indicate a bit depth about the channel features of output video. In this embodiment, the channels of output video are divided into luma and chroma in order to define a field indicating the bit depth of each channel. In another embodiment, a field indicating a single bit depth value applied to all of three channels (Red, Green, and Blue) of output video may be defined, or a field indicating the bit depth of each channel may be defined. That is, a broadcasting system according to an embodiment of the present invention may divide the channels of output video based on a specific criterion, and may independently signal a bit depth for each channel in order to signal different bit depths for respective channels. This field may have a value between 0 and 8.

The multi_output_color_signal_representation_flag field indicates whether a multi_output_color_signal_representation exists in this descriptor. When the value of this field is 1, this indicates that color signal representation information about i-th output video exists. In an embodiment of the present invention, when the value of this field is 0, this value may be set as a default value. For example, when the value of this field is 0, this may indicate that color signal representation information about i-th output video is YCbCr, which is included in SPS RBSP.

The multi_output_color_signal_representation field indicates information about a method of representing a color signal of output video. This field may have a value between 0 and 255. When the value of this field is 1, this indicates that the color of output video is represented as RGB. When the value of this field is 2, this indicates that the color of output video is represented as YCbCr (non-constant luminance). When the value of this field is 3, this indicates that the color of output video is represented as YCbCr (constant luminance).

A detailed description of the other fields included in this descriptor is substituted by the description of the above-described fields having the same names.

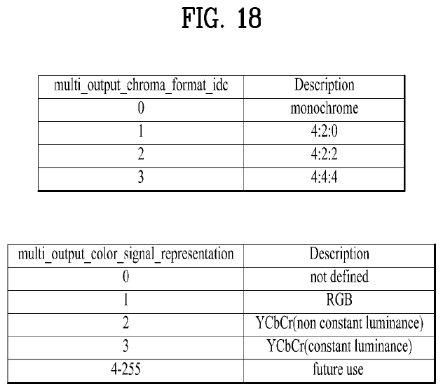

FIG. 18 is a view showing the description of values indicated by a multi_output_chroma_format_idc field and a multi_output_color_signal_representation field according to an embodiment of the present invention.

A detailed description of this figure corresponds to the description of the previous figure.

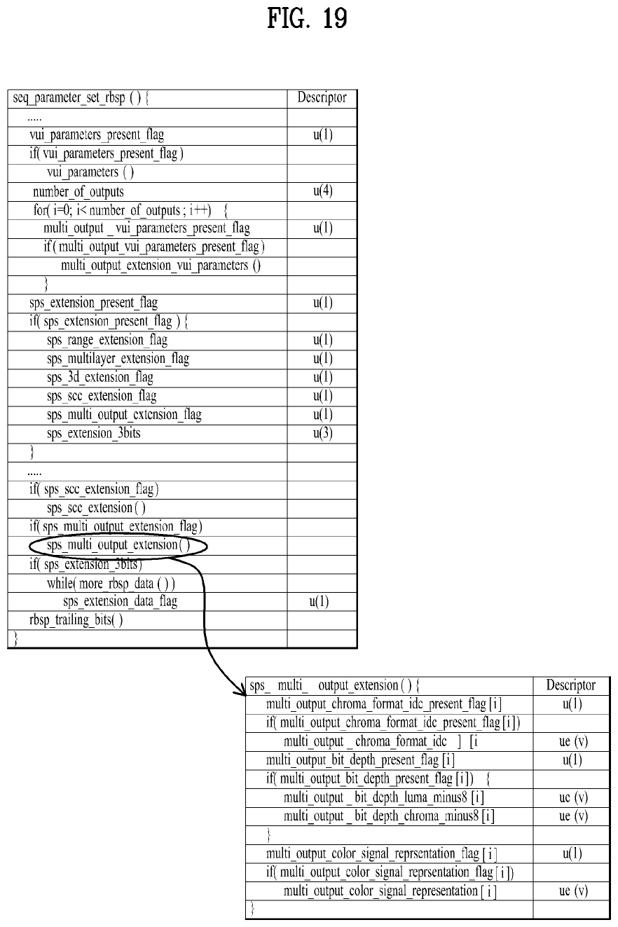

FIG. 19 is a view showing the syntax of SPS RBSP and an sps_multi_output_extension descriptor according to another embodiment of the present invention.

SPS RBSP according to another embodiment of the present invention may include VUI itself of output video, and at the same time may include an sps_multi_output_extension descriptor for signaling chroma sub-sampling information, a bit depth, and/or color signal representation information of the output video.

In another embodiment of the present invention, feature information of output video that is not signaled by VUI itself included in SPS RBSP may be signaled through an sps_multi_output_extension descriptor separately included in SPS RBSP, in addition to the chroma sub-sampling information.

SPS RBSP according to another embodiment of the present invention includes a number_of_outputs field, a multi_output_vui_parameters_present_flag field, a multi_output_extension_vui_parameters descriptor, an sps_multi_output_extension_flag field, and/or an sps_multi_output_extension descriptor. A detailed description of the above fields is substituted by the description of the above-described fields having the same names.

An sps_multi_output_extension descriptor according to another embodiment of the present invention may include a multi_output_chroma_format_idc_present_flag field, a multi_output_chroma_format_idc field, a multi_output_bit_depth_present_flag field, a multi_output_bit_depth_luma_minus8 field, a multi_output_bit_depth_chroma_minus8 field, a multi_output_color_signal_representation_flag field, and/or a multi_output_color_signal_representation field. A detailed description of the above fields is substituted by the description of the above-described fields having the same names.

In this embodiment, the sps_multi_output_extension descriptor may not include the fields about feature information of output video that has already been signaled through the multi_output_extension_vui_parameters descriptor.

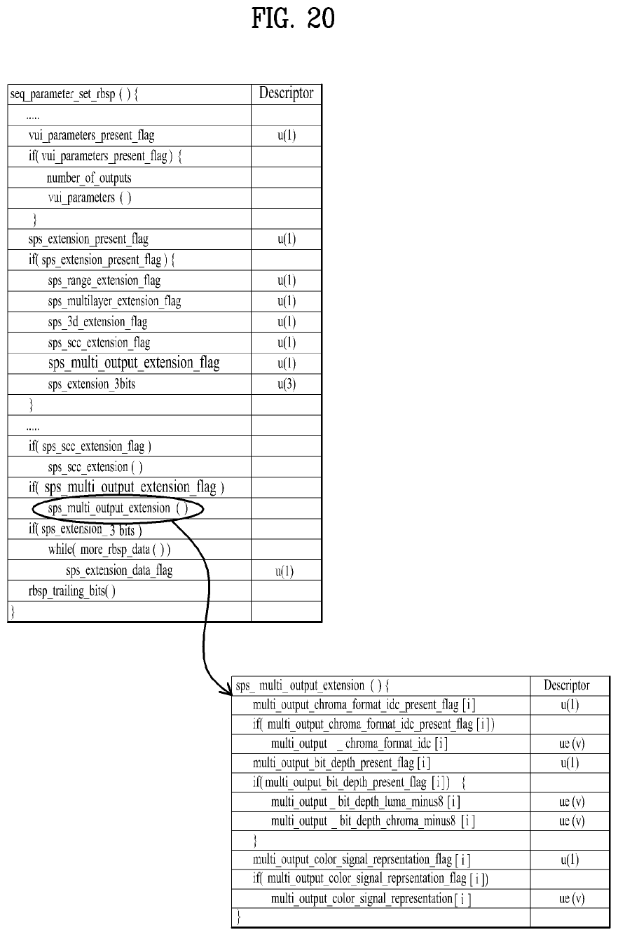

FIG. 20 is a view showing the syntax of SPS RBSP and an sps_multi_output_extension descriptor according to another embodiment of the present invention.

SPS RBSP according to another embodiment of the present invention may include a vui_parameters_present_flag field, a number_of_outputs field, a vui_parameters descriptor, an sps_multi_output_extension_flag field, and/or an sps_multi_output_extension descriptor. A detailed description of the above fields is substituted by the description of the above-described fields having the same names.

SPS RBSP according to this embodiment may signal a number of vui_parameters descriptors corresponding to the number of video outputs. Therefore, SPS RBSP according to this embodiment may not include the multi_output_vui_parameters_present_flag field and/or the multi_output_extension_vui_parameters descriptor, which are included in the embodiment described with reference to the previous figure.

In an embodiment of the present invention, when the decoder outputs two videos having different features, a broadcasting system according to an embodiment of the present invention may signal the features of each video as follows.

For example, in the case in which first output video has BT.709 color space, BT.2020 EOTF, 10 bits, and YCbCr 4:2:0 non-constant luminance formats, the first output video may be signaled using colour_primaries=1 (Rec. ITU-R BT.709), transfer_characteristics=14 (Rec. ITU-R BT.2020), and matrix_coeffs=9 (Rec. ITU-R BT.2020 non-CL) in VUI and using bit_depth_luma_minus8=2 (10-bit bitdepth), bit_depth_chroma_minus8=2 (10-bit bitdepth), and Chroma_format_idc=1 (4:2:0 color sub-sampling) in SPS.

In the case in which second output video has BT.2020 color space, ST 2084 EOTF, 12 bits, and RGB 4:4:4 constant luminance formats, the second output video may be signaled using number_of_outputs=1 (because the first output video is signaled in VUI), colour_primaries=9 (Rec. ITU-R BT.2020), output_transfer_characteristics=16 (SMPTE ST 2084), output_matrix_coeffs=10 (Rec. ITU-R BT.2020 CL), multi_output_chroma_format_idc=3 (4:4:4 color sub-sampling), multi_output_bit_depth_chroma_minus8=4 (12-bit bitdepth), multi_output_bit_depth_luma_minus8=4 (12-bit bitdepth), and multi_output_color_signal_representation=1 (RGB) in an sps_multi_output_extension descriptor according to an embodiment of the present invention.

In another example, the broadcasting system may set number_of_outputs in the sps_multi_output_extension descriptor to 2, and may define all the features of the first and second output videos in the sps_multi_output_extension descriptor.

Alternatively, the broadcasting system may signal the features of the first output video basically using existing VUI and/or SPS, and may signal the features of specific output video using the sps_multi_output_extension descriptor.

In this specification, the case in which the feature information of a plurality of videos is signaled through SPS RBSP and/or VUI is described. Alternatively, the feature information of a plurality of videos may be signaled through VPS, PPS, and/or an SEI using the same signaling method described in this specification.

FIG. 21 is a view showing the structure of a broadcast signal transmission and reception system according to another embodiment of the present invention.

A broadcasting system according to an embodiment of the present invention may signal information about an additional transfer function for HDR service.

When HDR (High Dynamic Range) content, in which rich luminance representation is possible, is provided, a broadcasting system according to an embodiment of the present invention may provide information about an additional transfer function applied to video such that a receiver can accurately reproduce an intended image.

A broadcasting system according to an embodiment of the present invention may apply an additional transfer function to content in order to more effectively reproduce an image, and may signal information about the additional transfer function applied to the content in order to provide an image having further improved quality.

A broadcasting system according to an embodiment of the present invention provides information about an additional transfer function (ATF).

A broadcasting system according to an embodiment of the present invention may signal an element about an additional transfer function used at the time of encoding, an element about an additional transfer function to be applied after decoding, a method of applying an additional transfer function, a parameter for applying an additional transfer function, and/or environment information for applying an additional transfer function.

In order to provide an image having improved color and luminance, environmental settings for optimal image processing and reproduction are necessary. A broadcasting system according to an embodiment of the present invention may signal relevant information for the environmental settings.

A broadcasting system according to an embodiment of the present invention proposes a method of effectively reproducing an image having luminance and color intended by a producer when content is reproduced on a display such that a user can watch an image having further improved quality.

This figure shows the structure of a broadcasting system according to an embodiment of the present invention. A broadcasting system according to an embodiment of the present invention includes a capture/film scan unit L21010, a post-production (mastering) unit L21020, an encoder/multiplexer L21030, a demultiplexer L21040, a decoder L21050, a post-processing unit L21060, an HDR display L21070, a metadata buffer L21080, and/or a synchronizer L21090. The capture/film scan unit L21010 captures and scans natural scenes to generate raw HDR video. The post-production (mastering) unit L21020 masters the HDR video to generate mastered HDR video and HDR metadata for signaling the features of the mastered HDR video. Color encoding information (a variable EOTF, an OOTF, and BT.2020), information about a mastering display, and information about a target display may be used in order to master the HDR video. The encoder/multiplexer L21030 encodes the mastered HDR video to generate an HDR stream and performs multiplexing with another stream to generate a broadcast stream. The demultiplexer L21040 receives and demultiplexes the broadcast stream to generate an HDR stream (an HDR video stream). The decoder L21050 decodes the HDR stream to output HDR video and HDR metadata. The metadata buffer L21080 receives the HDR metadata and delivers EOTF metadata and/or OOTF metadata, among the HDR metadata, to the post-processing unit. The synchronizer L21090 delivers timing information (timing info) to the metadata buffer and the post-processing unit. The post-processing unit L21060 post-processes the HDR video, received from the decoder, using the EOTF metadata and/or the timing information. The HDR display L21070 displays the post-processed HDR video.

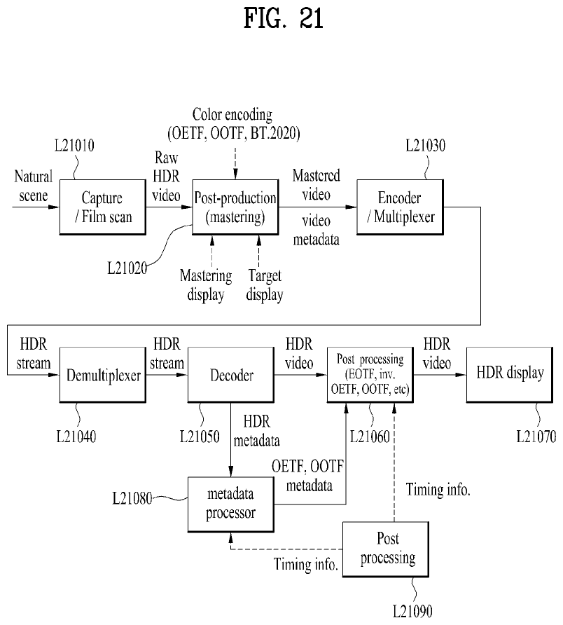

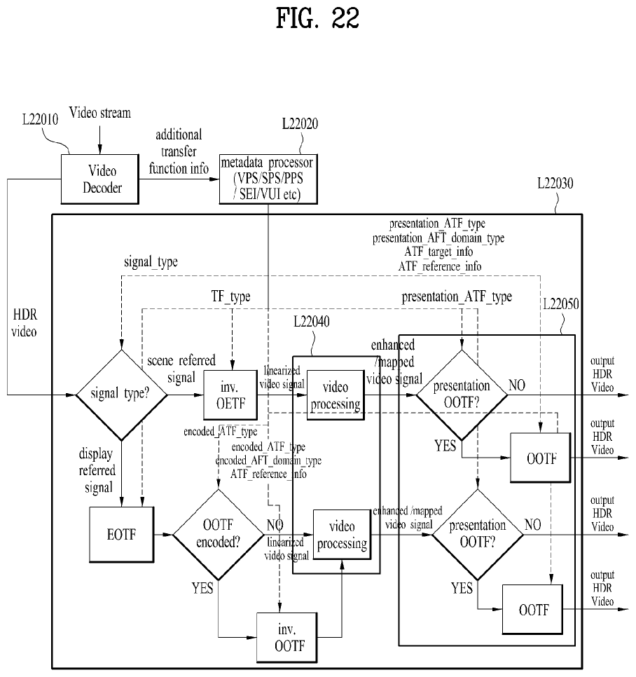

FIG. 22 is a view showing the structure of a broadcast signal reception apparatus according to another embodiment of the present invention.

In this specification, a description will be given mainly based on the operation of a receiver to which the present invention is applied. However, signaling information enabling the operation of the receiver may also be applied to a transmitter, and this signaling information may also be applied to a production process and/or a mastering process.

This figure shows the operation of the broadcast signal reception apparatus in the case in which detailed information about an ATF (additional transfer function) used at the time of transmitting content is delivered.

In an embodiment of the present invention, when a video stream is delivered to the receiver, a video decoder separately processes VPS, SPS, PPS, an SEI message, and/or VUI. Subsequently, the broadcast signal reception apparatus determines the performance of the receiver, and appropriately constructs an ATF applied to an image through additional transfer function information in order to display a final image.

In an embodiment, a broadcasting system according to another embodiment of the present invention uses an OOTF as an additional transfer function (ATF). The sequence of blocks shown in this figure may be changed.

A broadcast signal reception apparatus according to an embodiment of the present invention includes a video decoder L22010, a metadata processor L22020, a post-processing processor L22030, and/or a display (not shown). The post-processing processor includes a video-processing processor L22040 and/or a presentation additional transfer function application processor L22050.

A broadcast signal reception apparatus according to an embodiment of the present invention decodes a video stream and acquires additional transfer function information. Specifically, the video decoder acquires information contained in VPS, SPS, PPS, VUI, and/or an SEI message from the video stream and delivers the acquired information to the metadata processor. The metadata processor analyzes the information contained in VPS, SPS, PPS, VUI, and/or the SEI message. Here, the information contained in VPS, SPS, PPS, VUI, and/or the SEI message includes signal type information (signal type), transfer function type information (TF type), additional transfer function information, reference environment information, and/or target environment information.

A broadcast signal reception apparatus according to an embodiment of the present invention may operate differently depending on the type of video signal. Specifically, video signals may be sorted into a scene-referred signal and a display-referred signal depending on signal type information (signal_type) transmitted through VPS, SPS, PPS, VUI, and/or an SEI message. The broadcast signal reception apparatus may operate differently depending on the sorted video signal. Furthermore, the post-processing processor of the broadcast signal reception apparatus may determine whether an additional transfer function (ATF) is applied to a video signal received from the encoding end using the signal type information.

In the case in which the received video signal is a scene-referred signal, the post-processing processor may determine that an additional transfer function applied at the encoding end does not exist in the received video signal, and may convert the video signal into a linear signal using transfer function type information (TF type) transmitted through VPS, SPS, PPS, VUI, and/or an SEI message. The post-processing processor may perform a video-processing process on the converted linear signal. The post-processing processor may determine whether an additional transfer function (e.g. an OOTF) will be applied to the video signal using presentation additional transfer function type information (presentation_ATF_type) transmitted through VPS, SPS, PPS, VUI, and/or an SEI message. In the case in which the additional transfer function that will be applied is a linear function, the post-processing processor may output the video signal without additional processing. In the case in which the additional transfer function that will be applied is not a linear function, the post-processing processor may apply an OOTF defined in a standard or an arbitrarily defined OOTF to the video signal depending on the presentation additional transfer function type information.

In the case in which the received video signal is a display-referred signal, the post-processing processor may determine that an additional transfer function applied at the encoding end exists in the received video signal. For the accuracy of video processing, the post-processing processor may apply an inverse function of the transfer function applied at the time of encoding to the video signal using transfer function type information (TF type) transmitted through VPS, SPS, PPS, VUI, and/or an SEI message. The post-processing processor may identify the additional transfer function used at the time of encoding using encoded additional transfer function type information (encoded_ATF_type) transmitted through VPS, SPS, PPS, VUI, and/or an SEI message. Furthermore, the post-processing processor may apply an inverse function of the additional transfer function applied at the time of encoding to the video signal using encoded additional transfer function type information (encoded_ATF_type), encoded additional transfer function domain type information (encoded_ATF_domain_type), and additional transfer function reference information (ATF_reference_info) transmitted through VPS, SPS, PPS, VUI, and/or an SEI message. In an embodiment of the present invention, in the case in which both a transfer function and an additional transfer function are applied to the video signal at the encoding end, the post-processing processor may apply both an inverse function of the transfer function and an inverse function of the additional transfer function to the video signal in order to convert the video signal into a linear signal. The post-processing processor may determine whether an additional transfer function (e.g. an OOTF) will be applied to the video signal using presentation additional transfer function type information (presentation_ATF_type) transmitted through VPS, SPS, PPS, VUI, and/or an SEI message. In the case in which the additional transfer function that will be applied is a linear function, the post-processing processor may output the video signal without additional processing. In the case in which the additional transfer function that will be applied is not a linear function, the post-processing processor may apply an OOTF defined in a standard or an arbitrarily defined OOTF to the video signal depending on the presentation additional transfer function type information. At this time, an presentation additional transfer function (e.g. an OOTF), applied before final display, may be a function identical to the function indicated by the encoded additional transfer function type information (encoded_ATF_type) or a separate function indicated by the presentation additional transfer function type information (presentation_ATF_type).

A display according to an embodiment of the present invention may display finally processed video.

FIG. 23 is a view showing the operation of a video-processing processor and a presentation additional transfer function application processor of a post-processing processor according to an embodiment of the present invention.

A post-processing processor according to an embodiment of the present invention includes a video-processing processor L23010 and/or a presentation additional transfer function application processor L23020. The video-processing processor L23010 and the presentation additional transfer function application processor L23020 perform the same functions as the video-processing processor and the presentation additional transfer function application processor of the post-processing processor shown in the previous figure.

The video-processing processor may receive a linear video signal to which an inverse function of the transfer function and/or an inverse function of the additional transfer function are applied, and may perform dynamic range mapping and/or color gamut mapping.

The presentation additional transfer function application processor may perform the conversion of a color space based on presentation additional transfer function domain type information transmitted through VPS, SPS, PPS, VUI, and/or an SEI message, and may apply different OOTFs for respective channels (e.g. Red, Green, and Blue) of a video signal. Furthermore, the presentation additional transfer function application processor may apply an OOTF only to a specific channel of the video signal. The presentation additional transfer function application processor may set parameters of the OOTF using presentation additional transfer function type information (presentation_ATF_type), presentation additional transfer function parameter information (presentation_ATF_parameter), additional transfer function target information (ATF_target_info), and/or additional transfer function reference information (ATF_reference_info) transmitted through VPS, SPS, PPS, VUI, and/or an SEI message. Specifically, the presentation additional transfer function application processor may set OOTF parameters based on luminance information of the display, color temperature information of the display, luminance information of an ambient light source, color temperature information of the ambient light source, etc. (reference_max_display_luminance, reference_min_display_luminance, reference_display_white_point, reference_ambient_light_luminance, reference_ambient_light_white_point, target_max_display_luminance, target_min_display_luminance, target_display_white_point, target_ambient_light_luminance, and target_ambient_light_white_point) transmitted through the additional transfer function target information and/or the additional transfer function reference information.

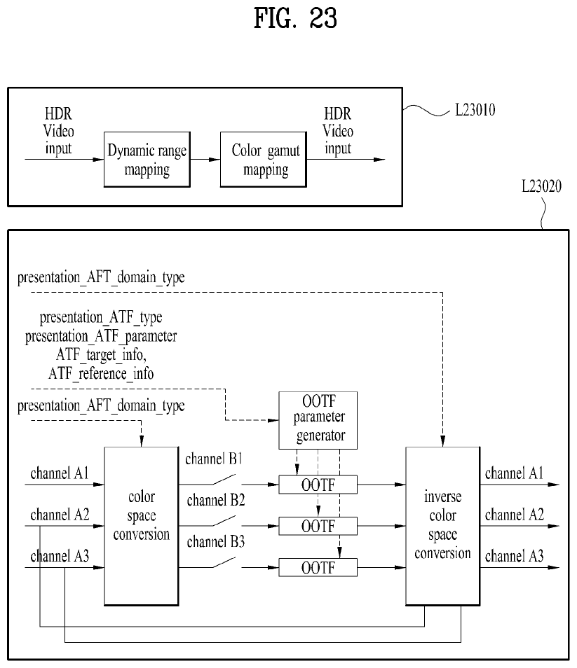

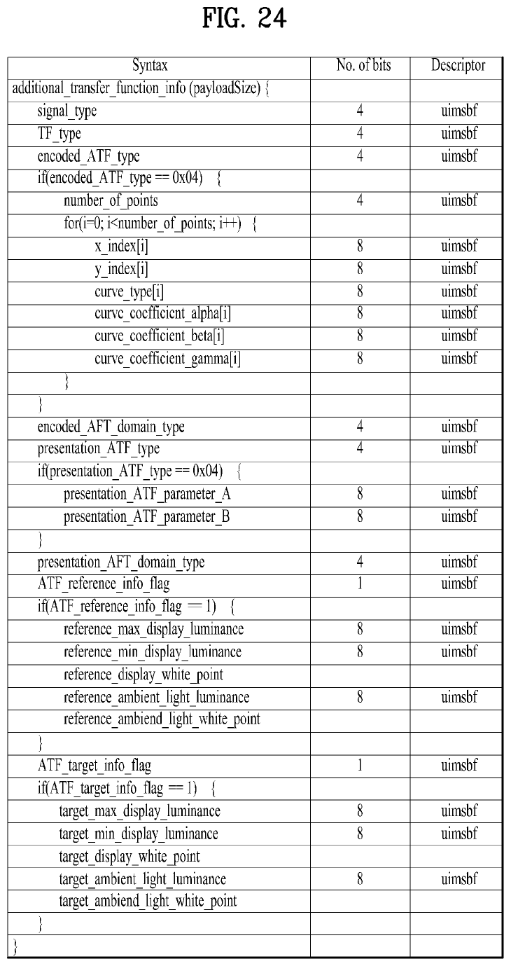

FIG. 24 is a view showing the syntax of an additional_transfer_function_info descriptor according to an embodiment of the present invention.

In this specification, a description will be given mainly based on the operation of a receiver to which the present invention is applied. Also, in this specification, a description will be given based on signaling through a video codec. However, signaling information enabling the operation of the receiver may also be applied to a transmitter, and this signaling information may also be applied to a production process, a mastering process, a wired/wireless interface between devices, a file format, and a broadcasting system. Also, in this specification, signaling information may be signaled through VUI, an SEI message, and/or system information as well as VPS, SPS, and/or PPS of a codec end.

An additional_transfer_function_info descriptor according to an embodiment of the present invention includes a signal_type field, a TF_type field, an encoded_ATF_type field, a number_of_points field, an x_index field, a y_index field, a curve_type field, a curve_coefficient_alpha field, a curve_coefficient_beta field, a curve_coefficient_gamma field, an encoded_ATF_domain_type field, a presentation_ATF_type field, a presentation_ATF_parameter_A field, a presentation_ATF_parameter_B field, a presentation_ATF_domain_type field, an ATF_reference_info_flag field, a reference_max_display_luminance field, a reference_min_display_luminance field, a reference_display_white_point field, a reference_ambient_light_luminance field, a reference_ambient_light_white_point field, an ATF_target_info_flag field, a target_max_display_luminance field, a target_min_display_luminance field, a target_display_white_point field, a target_ambient_light_luminance field, and/or a target_ambient_light_white_point field.

The signal_type field identifies the type of a video signal. In an embodiment of the present invention, the type of a video signal may be sorted based on the definition of a transfer function. In the case in which a transfer function is defined based on a display that reproduces video, a video signal may be identified as a display-referred video signal. In the case in which a transfer function is defined based on information itself, a video signal may be identified as a scene-referred video signal. When the value of this field is 0x01, this indicates that a video signal is a display-referred video signal. When the value of this field is 0x02, this indicates that a video signal is a scene-referred video signal. This field may be called signal type information. In an embodiment of the present invention, a video signal may be sorted as a signal the range of which is represented using an absolute value (a display-referred video signal) or a signal that is normalized and represented using a relative range (a scene-referred video signal). For example, when the maximum and minimum ranges of a signal are represented, the former (display-referred) may be represented using 0 to 1000 nit, and the latter (scene-referred) may be represented using a value of 0 to 1. Furthermore, the former may be used in a PQ system, and the latter may be used in an HLG system.

The TF_type field indicates the type of transfer function used for a video signal in order to transmit the video signal. This field may signal a transfer function itself, such as BT.2020 or SMPTE ST 2084, or may signal an additionally used function with the transfer function. At this time, an OOTF may be a fixed function that is promised in advance. When the value of this field is 0x01, this may indicate that type 1 (e.g. an inverse PQ (perceptual quantizer) of SMPTE ST 2084) is used as a transfer function. When the value of this field is 0x02, this may indicate that type 2 (e.g. an OOTF (opto-optical transfer function)+an inverse PQ) is used as a transfer function. When the value of this field is 0x03, this may indicate that type 3 (e.g. an inverse PQ+OOTF) is used as a transfer function. When the value of this field is 0x04, this may indicate that type 4 (e.g. HLG (hybrid log gamma)) is used as a transfer function. When the value of this field is 0x05, this may indicate that BT.2020 is used as a transfer function. This field may be called transfer function type information.

The encoded_ATF_type field indicates the type of an additional transfer function used for a video signal in order to transmit the video signal. In an embodiment of the present invention, a broadcasting system may not perform processing (in the case in which a linear function is used as an additional transfer function, 0x01), or may use a specific transfer function defined in a standard as an additional transfer function (0x02 and 0x03). Alternatively, the broadcasting system may use an arbitrary function as an additional transfer function, and may then transmit a parameter defining the arbitrary function (0x04). In an embodiment of the present invention, an OOTF is used as an example of a specific transfer function defined in a standard. This field may be used mainly for a display-referred video signal. When the value of this field is 0x01, this may indicate that a linear function is used as an additional transfer function. When the value of this field is 0x02, this may indicate that reference ATF type 1 (e.g. a PQ OOTF) is used as an additional transfer function. When the value of this field is 0x03, this may indicate that reference ATF type 2 (e.g. an HLG OOTF) is used as an additional transfer function. When the value of this field is 0x04, this may indicate that an arbitrary function (a parameterized ATF) is used as an additional transfer function.

In the case in which an arbitrary function is used as an additional transfer function, the number_of_points field indicates the number of periods existing in the arbitrary function.

The x_index field indicates an x-axis coordinate value of an i-th period of the arbitrary function.

The y_Index field indicates a y-axis coordinate value of the i-th period of the arbitrary function.

The curve_type field indicates the type of function corresponding to the i-th period of the arbitrary function. This field may indicate a linear function, a quadratic function, a high-order function, an exponential function, a log function, an s curve, a sigmoid function, etc.

The curve_coefficient_alpha field, the curve_coefficient_beta field, and the curve_coefficient_gamma field indicate parameters defining a function corresponding to the i-th period of the arbitrary function.

The encoded_ATF_domain_type field indicates the type of a color coordinate system to which an additional transfer function used for a video signal is applied. In an embodiment of the present invention, an additional transfer function may be applied to each RGB channel of a video signal, or may be converted into YCbCr and then applied to each YCbCr channel. Alternatively, an additional transfer function may be applied only to a Y channel of a video signal converted into YCbCr. YCbCr may be sorted as YCbCr constant luminance and YCbCr non-constant luminance. In an embodiment of the present invention, a broadcasting system may designate and signal the type of different color coordinates applied to a video signal before and after an additional transfer function is applied using this field. When the value of this field is 0x01, this indicates that the color coordinates to which an additional transfer function is applied are ATF domain type 1 (e.g. RGB). When the value of this field is 0x02, this indicates that color coordinates to which an additional transfer function is applied are ATF domain type 2 (e.g. YCbCr non-constant luminance). When the value of this field is 0x03, this indicates that color coordinates to which an additional transfer function is applied are ATF domain type 3 (e.g. YCbCr non-constant luminance, luminance only). When the value of this field is 0x04, this indicates that color coordinates to which an additional transfer function is applied are ATF domain type 4 (e.g. YCbCr non-constant luminance, channel-independent). When the value of this field is 0x05, this indicates that color coordinates to which an additional transfer function is applied are ATF domain type 5 (e.g. YCbCr constant luminance). When the value of this field is 0x06, this indicates that color coordinates to which an additional transfer function is applied are ATF domain type 6 (e.g. YCbCr constant luminance, luminance only). When the value of this field is 0x07, this indicates that color coordinates to which an additional transfer function is applied are ATF domain type 7 (e.g. YCbCr constant luminance, channel-independent).

The presentation_ATF_type field indicates the type of an additional transfer function that must be used or is recommended to be used when a video signal is output. This field may indicate a linear function requiring no special processing or a function defined in a standard. This field may indicate a fixed function that is not changed depending on an ambient environment or a function that is changed depending on an ambient environment. In the case in which a function that is changed depending on an ambient environment is used (0x04), the broadcasting system may further signal the presentation_ATF_parameter_A field and/or the presentation_ATF_parameter_B field, which indicate a variable causing the change of a function. In an embodiment of the present invention, in the case in which an arbitrary function is used as a presentation additional transfer function (0x05), number_of_points, x_index[i], y_mdex[i], curve_type[i], curve_coefficient_alpha[i], curve_coefficient_beta[i], and curve_coefficient_gamma[i] fields may be further signaled, like the case in which encoded_ATF_type=0x04. This field may be used for a scene-referred video signal. In this specification, an additional transfer function that must be used or is recommended to be used when a video signal is output is called a presentation additional transfer function. When the value of this field is 0x01, this indicates that a linear function is used as a presentation additional transfer function. When the value of this field is 0x02, this indicates that reference ATF type 1 (e.g. a PQ OOTF) is used as a presentation additional transfer function. When the value of this field is 0x03, this indicates that reference ATF type 2—(e.g. an HLG OOTF, a constant, or a function that is not changed depending on an ambient environment) is used as a presentation additional transfer function. When the value of this field is 0x04, this indicates that reference ATF type 3—(e.g. an HLG OOTF, a variable, or a function that is changed depending on an ambient environment) is used as a presentation additional transfer function. When the value of this field is 0x04, this indicates that an arbitrary function (a parameterized ATF) is used as a presentation additional transfer function.

The presentation_ATF_domain_type field indicates the type of color coordinates to which a presentation additional transfer function is applied. Detailed values of this field follow the description of the encoded_ATF_domain_type field.

The ATF_reference_info_flag field indicates whether this descriptor includes additional transfer function reference information indicating an environmental condition when an additional transfer function is applied. When the value of this field is 1, this indicates that this descriptor includes additional transfer function reference information. In this case, this descriptor includes a reference_max_display_luminance field, a reference_min_display_luminance field, a reference_display_white_point field, a reference_ambient_light_luminance field, and/or a reference_ambient_light_white_point field as additional transfer function reference information. The reference_max_display_luminance field and the reference_min_display_luminance field respectively indicate the maximum luminance and the minimum luminance of a display when an additional transfer function is applied. The reference_display_white_point field indicates the color temperature (white point) of a display when an additional transfer function is applied. The reference_ambient_light_luminance field indicates the luminance of an ambient light environment when an additional transfer function is applied. The reference_ambient_light_white_point field indicates the color temperature of an ambient light environment when an additional transfer function is applied. In another embodiment of the present invention, additional transfer function reference information may be signaled using a method defined in a standard. In this case, the broadcasting system may signal that additional transfer function reference information uses a method defined in a standard, and therefore may not actually signal additional transfer function reference information.

The ATF_target_info_flag field indicates whether this descriptor includes additional transfer function target information indicating a target environmental condition to which an additional transfer function is applied. Additional transfer function target information indicates an environmental condition ideal or appropriate to apply an additional transfer function. Alternatively, additional transfer function target information indicates an environmental condition as a target to which an additional transfer function is applied. When the value of this field is 1, this indicates that this descriptor includes additional transfer function target information. In this case, this descriptor includes a target_max_display_luminance field, a target_min_display_luminance field, a target_display_white_point field, a target_ambient_light_luminance field, and/or a target_ambient_light_white_point field as additional transfer function target information. The target_max_display_luminance field and the target_min_display_luminance field respectively indicate the maximum luminance and the minimum luminance of a display as a target to which an additional transfer function is applied. The target_display_white_point field indicates the color temperature (white point) of a display as a target to which an additional transfer function is applied. The target_ambient_light_luminance field indicates the luminance of an ambient light environment as a target to which an additional transfer function is applied. The target_ambient_light_white_point field indicates the color temperature of an ambient light environment as a target to which an additional transfer function is applied. In another embodiment of the present invention, additional transfer function target information may be signaled using a method defined in a standard. In this case, the broadcasting system may signal that additional transfer function target information uses a method defined in a standard, and therefore may not actually signal additional transfer function target information.

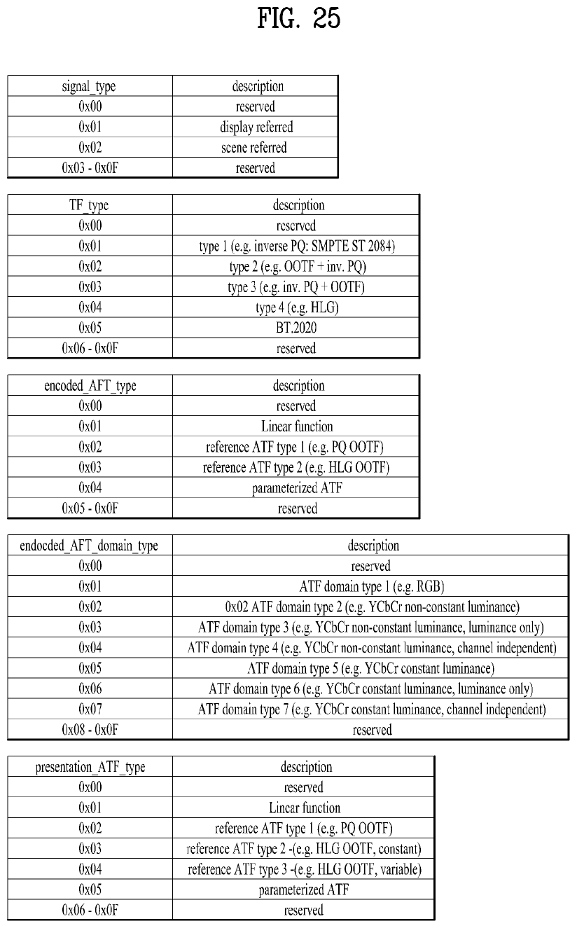

FIG. 25 is a view showing the description of values indicated by a signal_type field, a TF_type field, an encoded_ATF_type field, an encoded_ATF_domain_type field, and a presentation_ATF_type field according to an embodiment of the present invention.

A detailed description of this figure corresponds to the description of the previous figure.

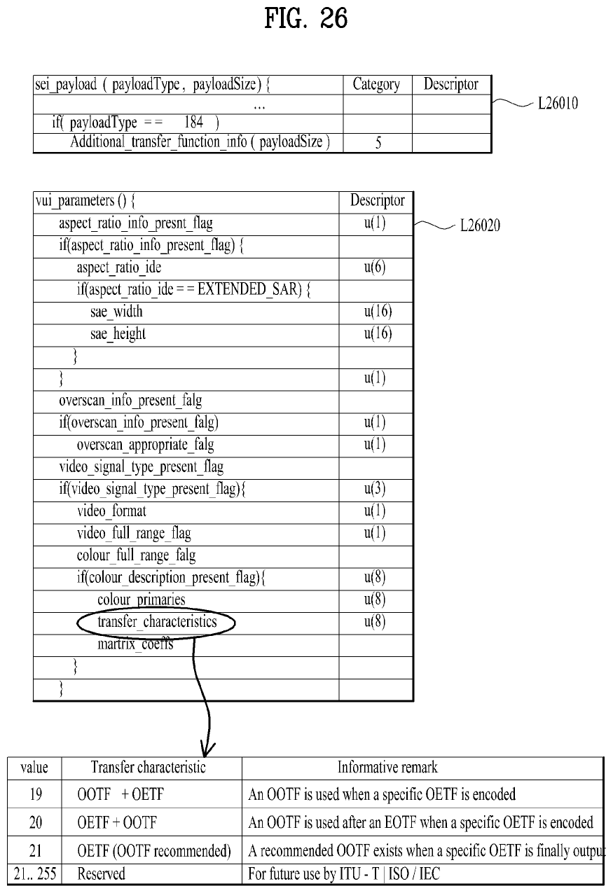

FIG. 26 is a view showing a method of signaling additional transfer function information according to an embodiment of the present invention.

A broadcasting system according to an embodiment of the present invention may signal additional transfer function information (additional_transfer_function_info) through HEVC video.

A broadcasting system according to an embodiment of the present invention may signal additional transfer function information using an SEI message. Referring to this figure (L26010), the broadcasting system may define an additional_transfer_function_info descriptor in an SEI message.

A broadcasting system according to an embodiment of the present invention may use a transfer_characteristic field of VUI in order to signal that an additional transfer function (e.g. an OOTF) is used. Referring to this figure (L26020), when the value of the transfer_characteristic field is 19, this indicates that an OOTF is used before an EOTF (or an OETF). When the value of the transfer_characteristic field is 20, this indicates that an OOTF is used after an EOTF (or an OETF). When the value of the transfer_characteristic field is 21, this indicates that a recommended OOTF exists when video is finally output.

A broadcasting system according to an embodiment of the present invention may signal brief information about an additional transfer function through VUI, and may signal detailed information about the additional transfer function through an SEI message.

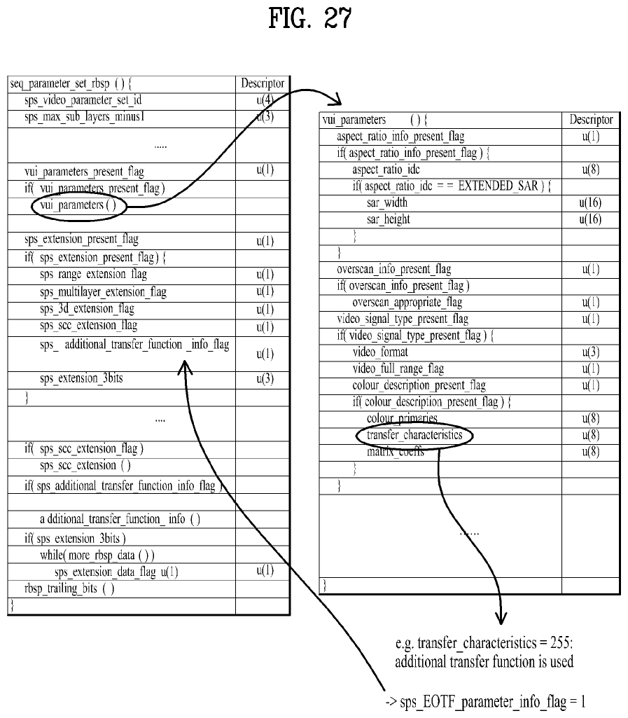

FIG. 27 is a view showing a method of signaling additional transfer function information according to another embodiment of the present invention.

A broadcasting system according to another embodiment of the present invention may define additional transfer function information (additional_transfer_function_info) in VUI to signal the information.

A broadcasting system according to another embodiment of the present invention may assign the value of a transfer_characteristics field in VUI to signal that additional transfer function information exists, and may signal additional transfer function information using VPS, SPS, PPS, and/or an SEI message.

This figure shows an embodiment of signaling additional transfer function information using SPS. The signaling method according to this figure may also be equally applied to the case in which VPS and/or PPS is used.

Referring to this figure, SPS RBSP information according to another embodiment of the present invention includes a vui_parameters descriptor, an sps_additional_transfer_function_info_flag field, and/or an additional_transfer_function_info descriptor.

A broadcasting system according to an embodiment of the present invention may signal that an additional transfer function is used for the video and that additional transfer function information exists in SPS RBSP using the value of the transfer_characteristics field of the vui_parameters descriptor in SPS RBSP, which is 255. At the same time, the broadcasting system may signal that an additional transfer function exists in SPS RBSP using the sps_additional_transfer_function_info_flag field in SPS RBSP, and may define the additional_transfer_function_info descriptor in SPS RBSP in order to signal additional transfer function information.

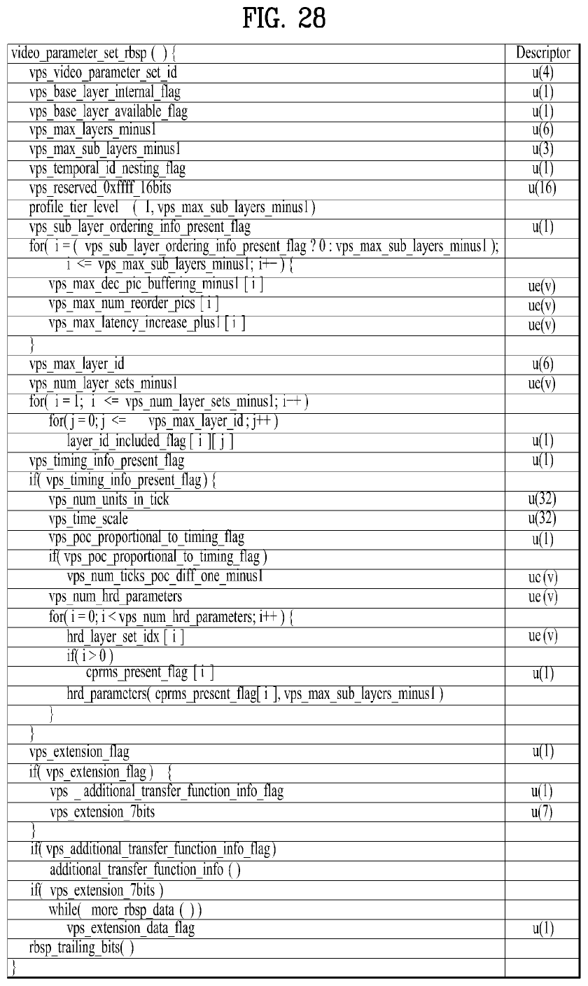

FIG. 28 is a view showing a method of signaling additional transfer function information according to another embodiment of the present invention.

A broadcasting system according to another embodiment of the present invention may signal additional transfer function information using VPS, SPS, PPS, and/or an SEI message.

This figure shows an embodiment of signaling additional transfer function information using VPS. A broadcasting system according to an embodiment of the present invention may set a vps_extension_flag field of VPS RBSP to 1, and may define a vps_additional_transfer_function_info_flag field and an additional_transfer_function_info descriptor in VPS RBSP in order to signal additional transfer function information. In the case in which the value of the vps_additional_transfer_function_info_flag field is 1, this indicates that additional transfer function information (additional_transfer_function_info descriptor) is included in VPS RBSP. In the case in which the value of this field is 0, this indicates that no additional transfer function information is included therein.

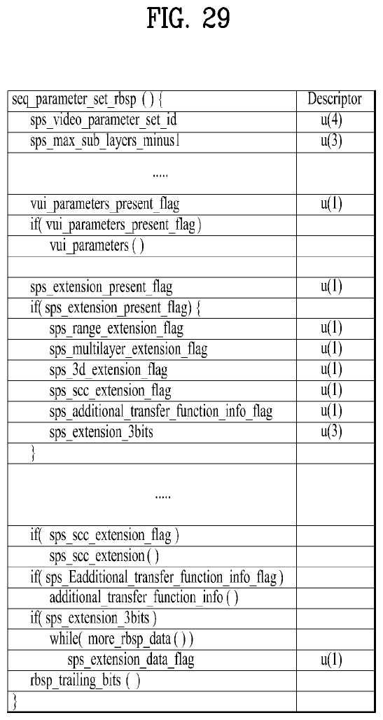

FIG. 29 is a view showing a method of signaling additional transfer function information according to another embodiment of the present invention.

This figure shows an embodiment of signaling additional transfer function information using SPS. A broadcasting system according to an embodiment of the present invention may set an sps_extension_present_flag field of SPS RBSP to 1, and may define an sps_additional_transfer_function_info_flag field and an additional_transfer_function_info descriptor in SPS RBSP in order to signal additional transfer function information. In the case in which the value of the sps_additional_transfer_function_info_flag field is 1, this indicates that additional transfer function information (additional_transfer_function_info descriptor) is included in SPS RBSP. In the case in which the value of this field is 0, this indicates that no additional transfer function information is included therein.

FIG. 30 is a view showing a method of signaling additional transfer function information according to a further embodiment of the present invention.

This figure shows an embodiment of signaling additional transfer function information using PPS. A broadcasting system according to an embodiment of the present invention may set a pps_extension_present_flag field of PPS RBSP to 1, and may define a pps_additional_transfer_function_info_flag field and an additional_transfer_function_info descriptor in PPS RBSP in order to signal additional transfer function information. In the case in which the value of the pps_additional_transfer_function_info_flag field is 1, this indicates that additional transfer function information (additional_transfer_function_info descriptor) is included in PPS RBSP. In the case in which the value of this field is 0, this indicates that no additional transfer function information is included therein.

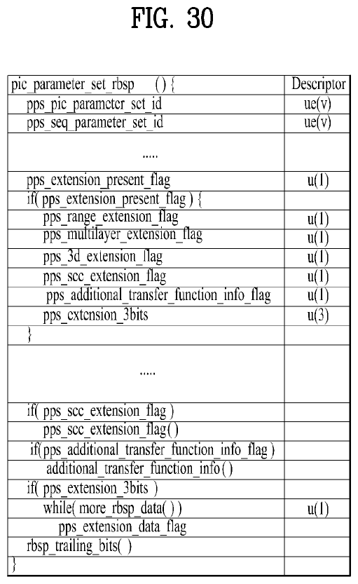

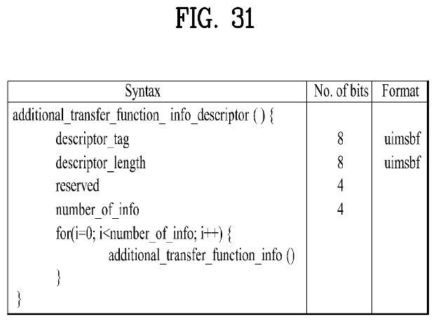

FIG. 31 is a view showing the syntax of additional_transfer_function_info_descriptor according to an embodiment of the present invention.

A method of signaling additional transfer function information according to an embodiment of the present invention may also be applied to production, post-production, broadcasting, transmission between devices, and storage-based file formats. Furthermore, additional transfer function information may be signaled by a broadcasting system using a system-level PMT or EIT.

In an embodiment of the present invention, a plurality of additional transfer function information may exist for one event. That is, additional transfer function information may not be consistently applied to content, but additional transfer function information may be changed over time or depending on whether inserted content exists. Furthermore, various additional transfer function modes intended by a producer may be supported for one piece of content. In an embodiment of the present invention, it is necessary to determine whether such additional transfer function modes can be accommodated in a display of a receiver, and information about each additional transfer function mode may be provided through additional transfer function information.

additional_transfer_function_info_descriptor according to an embodiment of the present invention may include a descriptor_tag field, a descriptor_length field, a number_of_info field, and/or additional_transfer_function_info (additional transfer function information). The descriptor_tag field indicates that this descriptor is a descriptor including additional transfer function information. The descriptor_length field indicates the length of this descriptor. The number_of_info field indicates the number of pieces of additional transfer function information provided by a producer. additional_transfer_function_info indicates additional transfer function information, which was previously described in detail.

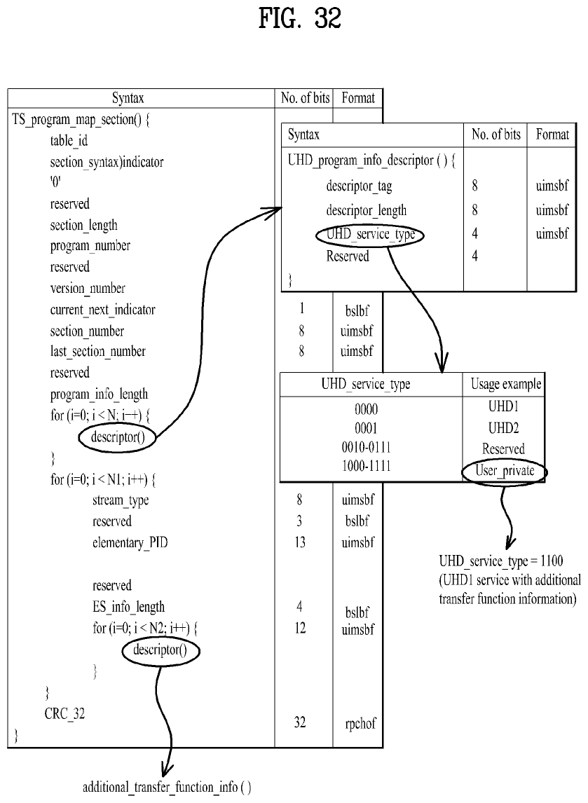

FIG. 32 is a view illustrating the case in which additional transfer function information according to an embodiment of the present invention is signaled through a PMT (program map table).

A broadcasting system according to an embodiment of the present invention may signal additional transfer function information using a system-level PMT and/or EIT (event information table) as well as SPS, VPS, PPS, VUI, and/or an SEI message, and may furthermore signal that the service is UHD service for which additional transfer function information is provided.

Additional transfer function information according to an embodiment of the present invention may be included in a stream-level descriptor of a PMT in the form of a descriptor (additional_transfer_function_info_descriptor).

UHD_program_info_descriptor according to an embodiment of the present invention may be included in a program-level descriptor of a PMT. UHD_program_info_descriptor includes descriptor_tag, descriptor_length, and/or UHD_service_type fields. descriptor_tag indicates that this descriptor is UHD_program_info_descriptor. descriptor_length indicates the length of this descriptor. UHD_service_type indicates the type of service. When the value of UHD_service_type is 0000, this indicates UHD1. When the value of UHD_service_type is 0001, this indicates UHD2. When the value of UHD_service_type is 0010-0111, this indicates reserved. When the value of UHD_service_type is 1000-1111, this indicates user_private. UHD_service_type according to an embodiment of the present invention provides information about the type of UHD service (e.g. the type of UHD service designated by a user, such as UHD1 (4K), UHD2 (8K), and classification based on image quality). Consequently, a broadcasting system according to an embodiment of the present invention may provide various UHD services. A broadcasting system according to an embodiment of the present invention may designate 1100 (UHD1 service with additional transfer function information, an example of 4K) as the value of UHD_service_type to indicate that HDR video information (HDR video info) including additional transfer function information is provided.

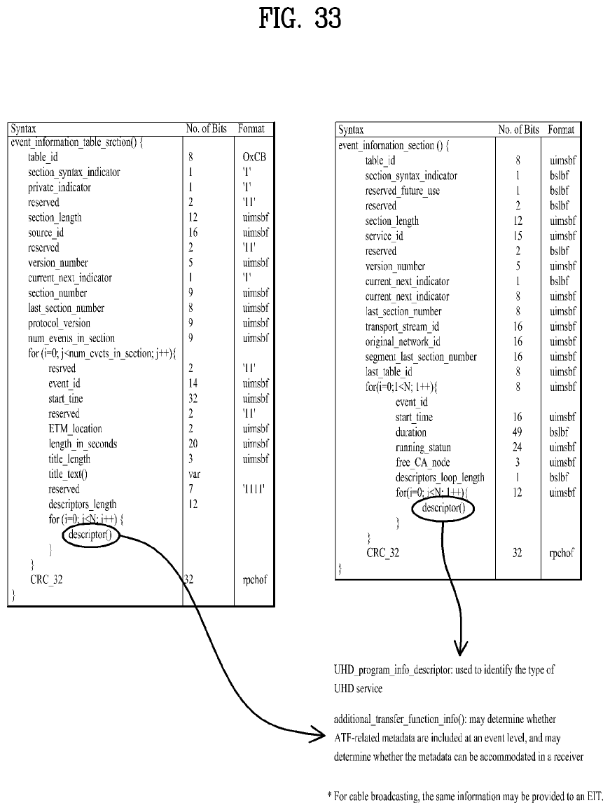

FIG. 33 is a view illustrating the case in which additional transfer function information according to an embodiment of the present invention is signaled through an EIT (event information table).

Additional transfer function information according to an embodiment of the present invention may be included in an event-level descriptor of an EIT in the form of a descriptor. Furthermore, UHD_program_info_descriptor, which was described with reference to the previous figure, may be included in an event-level descriptor of an EIT.

A receiver according to an embodiment of the present invention may confirm that the value of UHD_service_type of the EIT is 1100 (UHD1 service with additional transfer function information, example of 4K) to recognize that additional transfer function information is delivered.

In the case in which the value of UHD_service_type of the EIT is 0000 (UHD1 service), a receiver according to another embodiment of the present invention may determine whether additional_transfer_function_info_descriptor exists in order to recognize whether additional transfer function information is delivered.

A content provider according to an embodiment of the present invention may determine whether additional transfer function information can be used at a display of a receiver using additional_transfer_function_info_descriptor.

A receiver according to an embodiment of the present invention may determine in advance whether additional transfer function information is used for content that is reproduced at the present time or in the future using additional_transfer_function_info_descriptor, and perform settings for scheduled recording, etc. in advance.

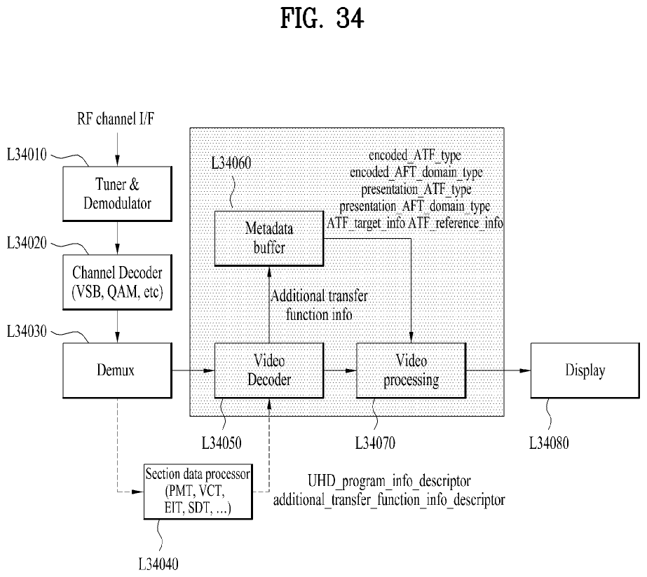

FIG. 34 is a view showing the structure of a broadcast signal reception apparatus according to another embodiment of the present invention.

In the case in which additional transfer function information is transmitted, a broadcast signal reception apparatus according to an embodiment of the present invention may analyze the information, and may apply the information to HDR video.

Specifically, the broadcast signal reception apparatus determines whether a separate service or medium is to be additionally received in order to construct an original UHDTV broadcast using received UHD_program_info_descriptor of a PMT. In the case in which UHD_service_type in UHD_program_info_descriptor of the PMT is 1100, a broadcast signal reception apparatus according to an embodiment of the present invention may determine that additional information (additional transfer function information) delivered through an SEI message exists. In the case in which UHD_service_type in UHD_program_info_descriptor is 0000 (0001 for 8K), a broadcast signal reception apparatus according to another embodiment of the present invention may determine that video-related additional information (additional transfer function information) delivered through an EIT and through an SEI message exists. Alternatively, in the case in which additional transfer function information as well as UHD_program_info_descriptor is directly included in an PMT and/or an EIT, the broadcast signal reception apparatus may receive the PMT and/or the EIT in order to immediately determine that additional transfer function information exists.

A broadcast signal reception apparatus according to an embodiment of the present invention identifies information about an additional transfer function (AFT) through VPS, SPS, PPS, an SEI message, VUI, additional_transfer_function_info_descriptor of the PMT, and/or additional_transfer_function_info_descriptor of the EIT. Specifically, broadcast signal reception apparatus may identify encoded_ATF_type, encoded_ATF_domain_type, presentation_ATF_type, presentation_ATF_domain_type, ATF_target_info, and ATF_reference_info.

A broadcast signal reception apparatus according to an embodiment of the present invention may convert a decoded image into a linear video signal based on the above-described additional transfer function information, may perform appropriate video processing, may apply an additional transfer function (e.g. an OOTF) to the video signal, and may display final video.

A broadcast signal reception apparatus according to an embodiment of the present invention may include a tuner L34010, a demodulator L34010, a channel decoder L34020, a demultiplexer (Demux) L34030, a section data processor L34040, a video decoder L34050, a metadata buffer L34060, a video-processing unit L34070, and/or a display L34080. The tuner may receive a broadcast signal including additional transfer function information and UHD content. The demodulator may demodulate the received broadcast signal. The channel decoder may channel-decode the demodulated broadcast signal. The demultiplexer may extract signaling information including additional transfer function information, video data, and audio data from the broadcast signal. The section data processor may process section data, such as a PMT, a VCT, an EIT, and an SDT, in the received signaling information. The video decoder may decode a received video stream. At this time, the video decoder may decode the video stream using information included in additional_transfer_function_info_descriptor and/or UHD_program_info_descriptor( ) included in the PMT and EIT extracted by the section data processor. The metadata buffer may store additional transfer function information that is transmitted through the video stream. The video-processing unit may apply an additional transfer function to video using the additional transfer function information received from the metadata buffer (encoded_ATF_type, encoded_ATF_domain_type presentation_ATF_type, presentation_ATF_domain_type, ATF_target_info, and ATF_reference_info). The display may display the video processed by the video-processing unit.

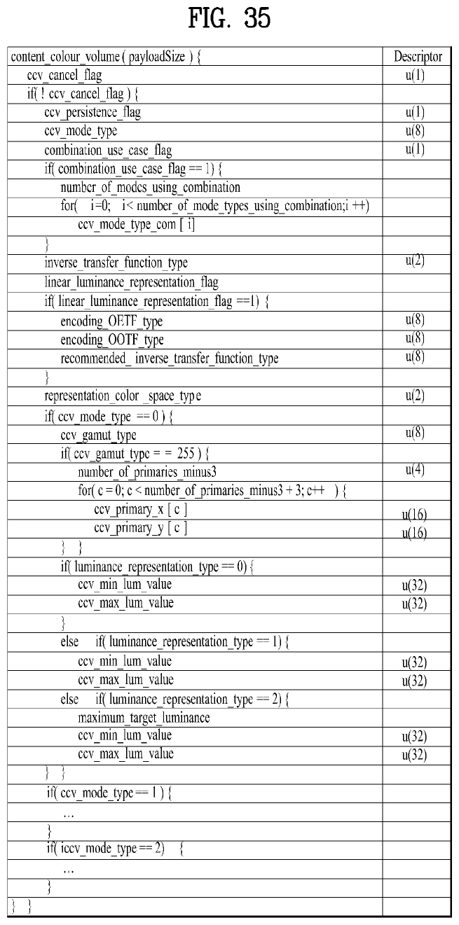

FIG. 35 is a view showing the syntax of a content_colour_volume descriptor according to an embodiment of the present invention.

A broadcasting system according to an embodiment of the present invention may signal color volume of content using a content_colour_volume descriptor. Furthermore, this descriptor may be signaled while being included in an SEI message. In another embodiment, this descriptor may be signaled while being included in VPS, SPS, PPS, and/or VUI.

In an embodiment of the present invention, color volume indicates the range of color. That is, color volume of content indicates the range of color represented by the content.

In an embodiment of the present invention, color volume of content may be signaled as a combination of the luminance value and the color gamut value of the content.

In another embodiment of the present invention, fields of the content_colour_volume descriptor, a description of which will follow, may be used to indicate container color volume and display color volume as well as color volume of content.

This figure shows an embodiment of representing color volume of a video signal represented using relative luminance or absolute luminance. In another embodiment of the present invention, information included in the content_colour_volume descriptor may be used to process an image or to represent content. Information included in the content_colour_volume descriptor may also be applied to image capture, production, transmission, and a digital interface as well as a broadcast transmission and reception system.

A content_colour_volume descriptor according to an embodiment of the present invention includes a ccv_cancel_flag field, a ccv_persistence_flag field, a ccv_mode_type field, a combination_use_case_flag field, a number_of_modes_using_combination field, a ccv_mode_type_com[i] field, an inverse_transfer_function_type field, a linear_luminance_representation_flag field, an encoding_OETF_type field, an encoding_OOTF_type field, a recommended_inverse_transfer_function_type field, a representation_color_space_type field, a ccv_gamut_type field, a number_of_primaries_minus3 field, a ccv_primary_x[c] field, a ccv_primary_y[c] field, a ccv_min_lum_value field, and/or a ccv_max_lum_value field.

The ccv_cancel_flag field indicates whether a previous SEI message delivering information of this descriptor is used. When the value of this field is 1, this indicates that no previous SEI message is used.

The ccv_persistence_flag field indicates that information that is delivered currently can be used for a subsequent image as well as the current image.

In the case in which color volume is represented in various modes, the ccv_mode_type field may be used to identify each mode. In the case in which several pieces of color volume information are delivered simultaneously through one SEI message or in the case in which different types of color volume information are delivered through different SEI messages, this field may be used to identify each piece of color volume information. In an embodiment of the present invention, in the case in which this field is used for identification based on regions, a previously defined method may be used together for region identification.

The combination_use_case_flag field indicates whether information about a combination mode, in which several color volume modes are used together, is transmitted. When the value of this field is 1, this indicates that information about a combination mode is transmitted.

The number_of_modes_using_combination field indicates the number of types of color volume modes that must be used together in a combination mode.

The ccv_mode_type_com[i] field indicates the type of each color volume mode that must be used together in a combination mode.

The inverse_transfer_function_type field indicates the type of an inverse function of a transfer function applied to a video signal.

The linear_luminance_representation_flag field indicates whether the range of luminance and the range of color signaled in this descriptor are represented based on linear color. When the value of this field is 1, this indicates that the range of luminance and the range of color are represented based on linear color. In this case, information about the range of luminance and the range of color may be used after a linear function is reconstructed through additionally given information. When the value of this field is 0, this indicates that the range of luminance and the range of color are represented in the domain of a signal itself. In this case, information about the range of luminance and the range of color may be used without additional processing.

The encoding_OETF_type field indicates information about an OETF, among functions used to encode content. In an embodiment of the present invention, this field may deliver information predefined in VUI, information about a function that is promised in advance and designated, or information about an arbitrary function.

The encoding_OOTF_type field indicates information about an OOTF, among functions used to encode content. In an embodiment of the present invention, this field may deliver predefined information, information about a function that is promised in advance and designated, or information about an arbitrary function.

The recommended_inverse_transfer_function_type field indicates a function that is recommended to be used in order to convert a nonlinear video signal to which an OETF and/or an OOTF is applied into a linear video signal. For example, this field may indicate an inverse function of a function defined in the encoding_OETF_type field and the encoding_OOTF_type field. This field may deliver predefined information, information about a function that is promised in advance and designated, or information about an arbitrary function.

The representation_color_space_type field indicates color space in which a video signal is represented. This field may indicate a color space such as RGB, CIELAB, YCbCr, and CIECAM02 LMS.

The ccv_gamut_type field indicates the type of a pre-designated color gamut in which a video signal is represented. This field may indicate that an arbitrary color gamut is used. In this case, an arbitrary color gamut may be defined using the number_of_primaries_minus3 field, the ccv_primary_x[c] field, and/or the ccv_primary_y[c] field.

The ccv_min_lum_value field indicates the minimum value of the range of luminance of a video signal. This field may have different meanings depending on the value of a luminance_representation_type field. When the value of the luminance_representation_type field is 0, the ccv_min_luminance_value field may indicate the minimum value of absolute luminance of a video signal in units of 0.0001 cd/m². When the value of the luminance_representation_type field is 1, the ccv_min_luminance_value field may indicate the minimum value of relative luminance of a video signal in units of 0.0001 within a range from 0 to 1 for a normalized luminance value. When the value of the luminance_representation_type field is 2, the ccv_min_lum_value field may indicate the minimum value of relative luminance of a video signal using the concept of absolute luminance. In this case, the minimum value relative to the set maximum value indicated by the value of a maximum_target_luminance field, which is provided separately, may be indicated in units of 0.0001 cd/m². (ccv_min_lum_value specifies the minimum luminance value, according to CIE 1931, that is expected to be used to specify the colour volume of present in the content. When transfer_characteristics=16, T the values of ccv_min_lum_value are in units of 0.0001 candelas per square metre. Otherwise, the values of ccv_min_lum_value are in units of 0.0001 where the values shall be in the range of 0 to 10000 in the linear representation.)

The ccv_max_lum_value field indicates the maximum value of the range of luminance of a video signal. This field may have different meanings depending on the value of the luminance_representation_type field. For example, when the value of the luminance_representation_type field is 0, the ccv_max_luminance_value field may indicate the maximum value of absolute luminance of a video signal in units of 0.0001 cd/m². When the value of the luminance_representation_type field is 1, the ccv_max_luminance_value field may indicate the maximum value of relative luminance of a video signal in units of 0.0001 within a range from 0 to 1 for a normalized luminance value. When the value of the luminance_representation_type field is 2, the ccv_min_lum_value field may indicate the maximum value of relative luminance of a video signal using a concept of absolute luminance. In this case, the maximum value relative to the set maximum value indicated by the value of the maximum_target_luminance field, which is provided separately, may be indicated in units of 0.0001 cd/m². (ccv_max_lum_value specifies the maximum luminance value, according to CIE 1931, that is expected to be present in the content. When transfer_characteristics=16, the values of ccv_max_lum_value are in units of 0.0001 candelas per square metre. Otherwise, the values of ccv_max_lum_value are in units of 0.0001 where the values shall be in the range of 0 to 10000 in the linear representation.)

In an embodiment of the present invention, the value of the range of luminance of a video signal may be changed depending on the value of the linear_luminance_representation_flag field. For example, on the assumption that absolute luminance has a range of a_min to a_max in a non-linear state, absolute luminance may have a range of b_min to b_max in a linear state. The relationship between the two values may be defined as follows. b_min=recommended_inverse_transfer_function {a_min}, and b_max=recommended_inverse_transfer_function {a_max}. Alternatively, b_min=inverse of encoding_OOTF {inverse of encoding_OETF {a_min}}, and b_max=inverse of encoding_OOTF {inverse of encoding_OETF {a_max}}. Here, recommended_inverse_transfer_function, encoding_OOTF, and encoding_OETF respectively indicate functions given by recommended_inverse_transfer_function_type, encoding_OOTF_type, and encoding_OETF_type. In an embodiment of the present invention, a receiver may convert the range of luminance and the range of color using the above relational expression, and may use the converted range of luminance and the converted range of color. Alternatively, the receiver may convert a video signal itself using the above relational expression, and may use the converted video signal based on a given range value.

The maximum_target_luminance field indicates reference maximum luminance used to represent a video signal, represented using relative luminance, using absolute luminance. The reference maximum luminance indicated by this field may mean the maximum luminance of a video signal itself, the maximum luminance that can be represented by a video signal (i.e. the maximum luminance of a container), the maximum luminance of a mastering display, and/or the maximum luminance of a target display.

In an embodiment of the present invention, the color space, the color gamut, and the range of luminance of a video signal may be signaled in order to signal the range of color (color volume) of the video signal.

A broadcast signal reception apparatus according to an embodiment of the present invention may receive color volume information of content, and may post-process a received video signal using the same in consideration of the environment of a display and intention at the time of production in order to generate and provide a video signal having optimum conditions.

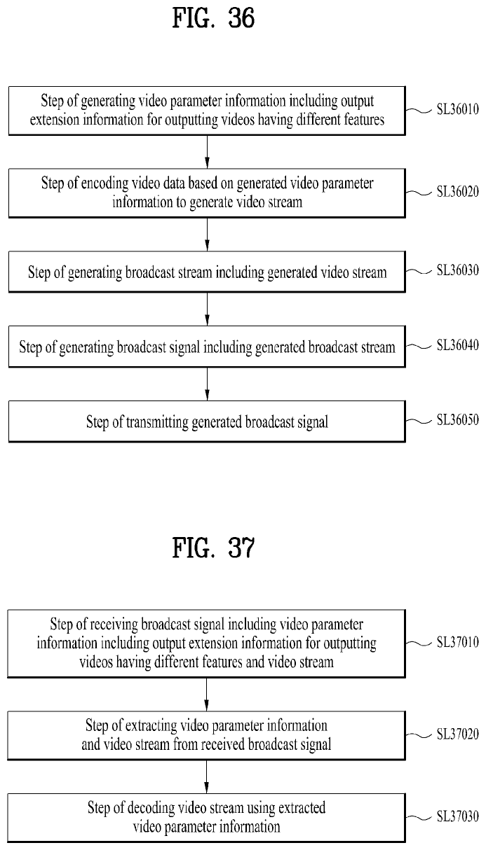

FIG. 36 is a view showing a broadcast signal transmission method according to an embodiment of the present invention.

A broadcast signal transmission method according to an embodiment of the present invention includes a step of generating video parameter information including output extension information for outputting a plurality of videos having different features (SL36010), a step of encoding video data based on the generated video parameter information to generate a video stream (SL36020), a step of generating a broadcast stream including the generated video stream (SL36030), a step of generating a broadcast signal including the generated broadcast stream (SL36040), and/or a step of transmitting the generated broadcast signal (SL36050). Here, the video parameter information may include flag information indicating whether the output extension information exists in the video parameter information, and the output extension information may include information indicating the number of videos that will be output and video feature information indicating the features of each video.

In another embodiment of the present invention, the video feature information may include information indicating the type of transfer function applied to each video, information indicating a color gamut applied to each video, information indicating a color space applied to each video, and information indicating whether data values of each video are defined within a digital representation range.

In another embodiment of the present invention, the video feature information may include chroma sub-sampling information of each video, information indicating a bit depth of each video, and information indicating a method of representing the color of each video.

In another embodiment of the present invention, the video parameter information may include additional transfer function information describing information about an additional transfer function, which is additionally applied to the video stream, in addition to a transfer function that is fundamentally applied to the video stream and flag information indicating whether the additional transfer function information exists in the video parameter information.

In another embodiment of the present invention, the additional transfer function information may include information indicating the type of a first additional transfer function applied to the video stream, information indicating the type of a color coordinate system to which the first additional transfer function is applied, information indicating the type of a second additional transfer function to be applied when video transmitted by the video stream is output, reference environmental condition information to which reference is to be made when the second additional transfer function is applied, and target environmental condition information as a target when the second additional transfer function is applied.

In another embodiment of the present invention, the broadcast signal may include content color volume information describing information about color volume indicating a range of color in which content transmitted by the video stream is represented, and the content color volume information may include flag information indicating whether the color volume is represented based on a linear color environment and information indicating a function used to convert a nonlinear video to which a transfer function is applied into a linear video.

FIG. 37 is a view showing a broadcast signal reception method according to an embodiment of the present invention.

A broadcast signal reception method according to an embodiment of the present invention includes a step of receiving a broadcast signal including video parameter information including output extension information for outputting a plurality of videos having different features and a video stream (SL37010), a step of extracting the video parameter information and the video stream from the received broadcast signal (SL37020), and/or a step of decoding the video stream using the extracted video parameter information (SL37030). Here, the video parameter information may include flag information indicating whether the output extension information exists in the video parameter information, and the output extension information may include information indicating the number of videos that will be output and video feature information indicating the features of each video.

In another embodiment of the present invention, the video feature information may include information indicating the type of transfer function applied to each video, information indicating a color gamut applied to each video, information indicating a color space applied to each video, and information indicating whether data values of each video are defined within a digital representation range.

In another embodiment of the present invention, the video feature information may include chroma sub-sampling information of each video, information indicating a bit depth of each video, and information indicating a method of representing color of each video.

In another embodiment of the present invention, the video parameter information may include additional transfer function information describing information about an additional transfer function, which is additionally applied to the video stream, in addition to a transfer function that is fundamentally applied to the video stream and flag information indicating whether the additional transfer function information exists in the video parameter information.

In another embodiment of the present invention, the additional transfer function information may include information indicating the type of a first additional transfer function applied to the video stream, information indicating the type of a color coordinate system to which the first additional transfer function is applied, information indicating the type of a second additional transfer function to be applied when video transmitted by the video stream is output, reference environmental condition information to which reference is to be made when the second additional transfer function is applied, and target environmental condition information as a target when the second additional transfer function is applied.

In another embodiment of the present invention, the broadcast signal may include content color volume information describing information about color volume indicating a range of color in which content transmitted by the video stream is represented, and the content color volume information may include flag information indicating whether the color volume is represented based on a linear color environment and information indicating a function used to convert a nonlinear video to which a transfer function is applied into a linear video.

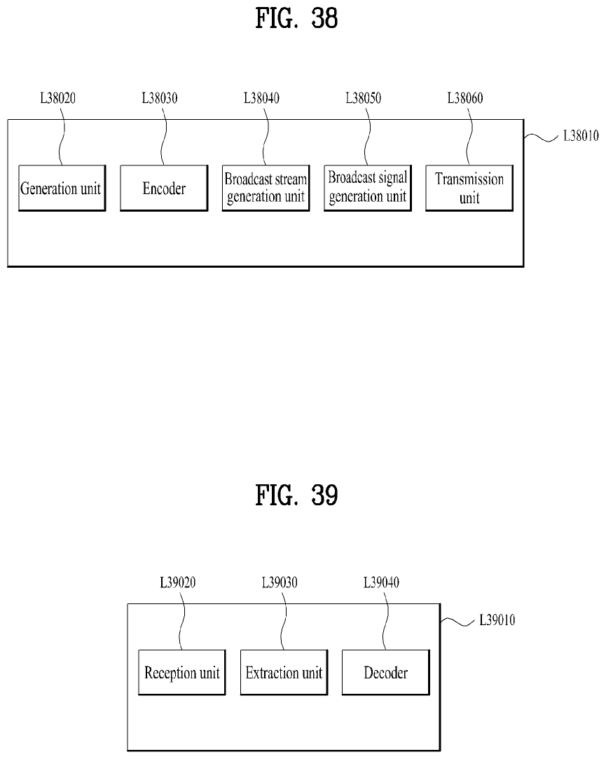

FIG. 38 is a view showing the structure of a broadcast signal transmission apparatus according to an embodiment of the present invention.

A broadcast signal transmission apparatus L38010 according to an embodiment of the present invention may include a generation unit L38020 for generating video parameter information including output extension information for outputting a plurality of videos having different features, an encoder L38030 for encoding video data based on the generated video parameter information to generate a video stream, a broadcast stream generation unit L38040 for generating a broadcast stream including the generated video stream, a broadcast signal generation unit L38050 for generating a broadcast signal including the generated broadcast stream, and/or a transmission unit L38060 for transmitting the generated broadcast signal. Here, the video parameter information may include flag information indicating whether the output extension information exists in the video parameter information, and the output extension information may include information indicating the number of videos that will be output and video feature information indicating the features of each video.

FIG. 39 is a view showing the structure of a broadcast signal reception apparatus according to an embodiment of the present invention.

A broadcast signal reception apparatus L39010 according to an embodiment of the present invention may include a reception unit L39020 for receiving a broadcast signal including video parameter information including output extension information for outputting a plurality of videos having different features and a video stream, an extraction unit L39030 for extracting the video parameter information and the video stream from the received broadcast signal, and/or a decoder L39040 for decoding the video stream using the extracted video parameter information. Here, the video parameter information may include flag information indicating whether the output extension information exists in the video parameter information, and the output extension information may include information indicating the number of videos that will be output and video feature information indicating the features of each video.

Modules or units may be processors that execute consecutive processes stored in a memory (or a storage unit). The steps described in the above-described embodiments may be performed by hardware/processors. The modules/blocks/units described in the above-described embodiments may operate as hardware/processors. In addition, the methods proposed by the present invention may be executed as code. Such code may be written on a processor-readable storage medium and thus may be read by a processor provided by an apparatus.

While the present invention has been described with reference to separate drawings for the convenience of description, new embodiments may be implemented by combining the embodiments illustrated in the respective drawings. As needed by those skilled in the art, designing a computer-readable recording medium, in which a program for implementing the above-described embodiments is recorded, falls within the scope of the present invention.

The apparatus and method according to the present invention are not limitedly applied to the constructions and methods of the embodiments as previously described; rather, all or some of the embodiments may be selectively combined to achieve various modifications.

Meanwhile, the method proposed by the present invention may be implemented as code that can be written on a processor-readable recording medium and thus read by a processor provided in a network device. The processor-readable recording medium may be any type of recording device in which data are stored in a processor-readable manner. The processor-readable recording medium may include, for example, read-only memory (ROM), random access memory (RAM), compact disc read-only memory (CD-ROM), magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

In addition, it will be apparent that, although the preferred embodiments have been shown and described above, the present specification is not limited to the above-described specific embodiments, and various modifications and variations can be made by those skilled in the art to which the present invention pertains without departing from the gist of the appended claims. Thus, it is intended that such modifications and variations should not be understood independently of the technical spirit or prospect of the present specification.

In addition, the present specification describes both a product invention and a method invention, and descriptions of the two inventions may be complementarily applied as needed.

Those skilled in the art will appreciate that the present invention may be carried out in other specific ways than those set forth herein without departing from the spirit or essential characteristics of the present invention. Therefore, the scope of the invention should be determined by the appended claims and their legal equivalents, rather than by the above description, and all changes that fall within the meaning and equivalency range of the appended claims are intended to be embraced herein.

This specification describes both an apparatus invention and a method invention, and descriptions of the apparatus and method inventions may be complementarily applied.

### MODE FOR INVENTION

Various embodiments have been described in the best mode for carrying out the invention.

### INDUSTRIAL APPLICABILITY

The present invention is used in various broadcast signal provision fields.

Those skilled in the art will appreciate that the present invention may be carried out in other specific ways than those set forth herein without departing from the spirit or essential characteristics of the present invention. Therefore, the scope of the invention should be determined by the appended claims and their legal equivalents, rather than by the above description, and all changes that fall within the meaning and equivalency range of the appended claims are intended to be embraced herein.

1. A method of transmitting a broadcast signal, the method comprising:
generating video parameter information including output extension information for outputting a plurality of videos having different features, wherein the video parameter information includes flag information indicating whether the output extension information exists in the video parameter information, and wherein the output extension information includes information indicating a number of videos that will be output and video feature information indicating features of each video;
encoding video data based on the generated video parameter information to generate a video stream;
generating a broadcast stream including the generated video stream;
generating the broadcast signal including the generated broadcast stream; and
transmitting the generated broadcast signal.

2. The method according to claim 1, wherein the video feature information includes information indicating a type of a transfer function applied to each video, information indicating a color gamut applied to each video, information indicating a color space applied to each video, and information indicating whether data values of each video are defined within a digital representation range.

3. The method according to claim 1, wherein the video feature information includes chroma sub-sampling information of each video, information indicating a bit depth of each video, and information indicating a method of representing color of each video.

4. The method according to claim 1, wherein the video parameter information includes additional transfer function information describing information about an additional transfer function, which is additionally applied to the video stream, in addition to a transfer function that is fundamentally applied to the video stream and flag information indicating whether the additional transfer function information exists in the video parameter information.

5. The method according to claim 4, wherein the additional transfer function information includes information indicating a type of a first additional transfer function applied to the video stream, information indicating a type of a color coordinate system to which the first additional transfer function is applied, information indicating a type of a second additional transfer function to be applied when video transmitted by the video stream is output, reference environmental condition information to which reference is to be made when the second additional transfer function is applied, and target environmental condition information as a target when the second additional transfer function is applied.

6. The method according to claim 1, wherein the broadcast signal includes content color volume information describing information about color volume indicating a range of color in which content transmitted by the video stream is represented, and
wherein the content color volume information includes flag information indicating whether the color volume is represented based on a linear color environment and information indicating a function used to convert a nonlinear video to which a transfer function is applied into a linear video.

7. A method of receiving a broadcast signal, the method comprising:
receiving the broadcast signal including video parameter information and a video stream, the video parameter information including output extension information for outputting a plurality of videos having different features, wherein the video parameter information includes flag information indicating whether the output extension information exists in the video parameter information and wherein the output extension information includes information indicating a number of videos that will be output and video feature information indicating features of each video;
extracting the video parameter information and the video stream from the received broadcast signal; and
decoding the video stream using the extracted video parameter information.

8. The method according to claim 7, wherein the video feature information includes information indicating a type of a transfer function applied to each video, information indicating a color gamut applied to each video, information indicating a color space applied to each video, and information indicating whether data values of each video are defined within a digital representation range.

9. The method according to claim 7, wherein the video feature information includes chroma sub-sampling information of each video, information indicating a bit depth of each video, and information indicating a method of representing color of each video.

10. The method according to claim 7, wherein the video parameter information includes additional transfer function information describing information about an additional transfer function, which is additionally applied to the video stream, in addition to a transfer function that is fundamentally applied to the video stream and flag information indicating whether the additional transfer function information exists in the video parameter information.

11. The method according to claim 10, wherein the additional transfer function information includes information indicating a type of a first additional transfer function applied to the video stream, information indicating a type of a color coordinate system to which the first additional transfer function is applied, information indicating a type of a second additional transfer function to be applied when video transmitted by the video stream is output, reference environmental condition information to which reference is to be made when the second additional transfer function is applied, and target environmental condition information as a target when the second additional transfer function is applied.

12. The method according to claim 7, wherein the broadcast signal includes content color volume information describing information about color volume indicating a range of color in which content transmitted by the video stream is represented, and
wherein the content color volume information includes flag information indicating whether the color volume is represented based on a linear color environment and information indicating a function used to convert a nonlinear video to which a transfer function is applied into a linear video.

13. An apparatus for transmitting a broadcast signal, the apparatus comprising:
a generation unit for generating video parameter information including output extension information for outputting a plurality of videos having different features, wherein the video parameter information includes flag information indicating whether the output extension information exists in the video parameter information, and wherein the output extension information includes information indicating a number of videos that will be output and video feature information indicating features of each video;
an encoder for encoding video data based on the generated video parameter information to generate a video stream;
a broadcast stream generation unit for generating a broadcast stream including the generated video stream;
a broadcast signal generation unit for generating the broadcast signal including the generated broadcast stream; and
a transmission unit for transmitting the generated broadcast signal.

14. An apparatus for receiving a broadcast signal, the apparatus comprising:
a reception unit for receiving the broadcast signal including video parameter information and a video stream, the video parameter information including output extension information for outputting a plurality of videos having different features, wherein the video parameter information includes flag information indicating whether the output extension information exists in the video parameter information, and wherein the output extension information includes information indicating a number of videos that will be output and video feature information indicating features of each video;
an extraction unit for extracting the video parameter information and the video stream from the received broadcast signal; and
a decoder for decoding the video stream using the extracted video parameter information.
